(19) United States
(12) Patent Application Publication
(10) Pub. No.: US 2014/0012749 A1
(43) Pub. Date: Jan. 9, 2014

(54) ELECTRONIC WALLET BASED REMITTANCE

(71) Applicant: KT Corporation, Seongnam-si (KR)

(72) Inventors: Sang-Yup LEE, Seoul (KR); Soochul PARK, Seongnam-si (KR); Ki-Min OH, Seoul (KR)

(21) Appl. No.: 13/930,252

(22) Filed: Jun. 28, 2013

(30) Foreign Application Priority Data
Jun. 29, 2012 (KR) 10-2012-0070853

(51) Int. Cl. G06Q 20/36

(52) U.S. Cl. CPC G06Q 20/367
USPC 705/40

(57) ABSTRACT

In at least one example embodiment, a method performed by a server includes issuing a first electronic wallet to be hosted on a first device; receiving, from the first device, a request including a remittance amount and an identifier of a second device; determining whether a second electronic wallet has been issued to be hosted on the second device; transmitting, to a bank, a request to deposit the remittance amount from a first virtual account corresponding to the first electronic wallet to a virtual account corresponding to the server, if a result of the determining is negative; and transmitting a request to accept the deposited remittance amount to the second device.

### TECHNICAL FIELD

The embodiments described herein pertain generally to remittance services utilizing an electronic wallet hosted on an end device.

### BACKGROUND

As mobile communication systems become ubiquitous, people can make a remittance by using an end device without having to hand over cash, a credit or debit card, or otherwise utilize banking services including automatic teller machines.

### SUMMARY

In one example embodiment, there is provided a method performed by a server that includes issuing a first electronic wallet to be hosted on a first device; receiving, from the first device, a request including a remittance amount and an identifier of a second device; determining whether a second electronic wallet has been issued to be hosted on the second device; transmitting, to a bank, a request to deposit the remittance amount from a first virtual account corresponding to the first electronic wallet to a virtual account corresponding to the server, if an issued result of the determining is negative; and transmitting a request to accept the deposited remittance amount at the second device.

In another example embodiment, there is provided a server that includes a processor configured to issue a first electronic wallet to be hosted on a first device; a receiver configured to receive, from the first device, a request that includes a remittance amount and an identifier of a second device; a determiner configured to determine whether a second electronic wallet has been issued to be hosted on the second device; a transmitter configured to transmit, to the bank, a request to deposit the remittance amount from a first virtual account that corresponds to the first electronic wallet to a virtual account corresponding to the server, if the second electronic wallet has not been issued; and the transmitter configured to transmit, to the second device, a request to accept the deposited remittance amount.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration in which one or more embodiments of electronic wallet based remittance may be implemented;

FIG. 2 shows an example processing flow of operations to implement at least portions of issuing a first electronic wallet and to generate a corresponding first virtual account;

FIG. 3 shows an illustrative example of a first device in which one or more embodiments of electronic wallet based remittance may be implemented;

FIG. 4 shows an example processing flow of operations for implementing at least portions of requesting for remittance utilizing a first electronic wallet.

FIG. 5 shows a user interface for making a remittance displayed on a first device in which one or more embodiments of electronic wallet based remittance may be implemented;

FIG. 6 shows an example processing flow of operations for implementing at least portions of completing a remittance utilizing a first electronic wallet;

FIG. 7 shows yet another example processing flow of operations for implementing at least portions of completing a remittance utilizing a first electronic wallet;

FIG. 8 shows yet further example processing flow of operations for implementing at least portions of completing a remittance utilizing a first electronic wallet;

FIG. 9 shows still another example processing flow of operations for implementing at least portions of completing a remittance utilizing a first electronic wallet;

FIG. 10 shows yet another example system configuration in which one or more embodiments of electronic wallet based remittance may be implemented;

FIGS. 11A and 11B together show an example processing flow of operations for implementing at least portions of making a remittance utilizing a first electronic wallet;

FIG. 12 shows yet another illustrative example of a first device in which one or more embodiments of electronic wallet based payment may be implemented;

FIG. 13 shows an example processing flow of operations for implementing at least portions of increasing a current balance corresponding to a first electronic wallet;

FIG. 14 shows yet another example processing flow of operations for implementing at least portions of increasing a current balance corresponding to a first electronic wallet;

FIG. 15 shows an example configuration of a server by which at least portions of electronic wallet based remittance may be implemented;

FIG. 16 shows still another example configuration of a server by which at least portions of electronic wallet based remittance may be implemented;

FIG. 17 shows an example configuration of a service providing manager by which at least portions of electronic wallet based remittance may be implemented; and

FIG. 18 shows an illustrative computing embodiment, in which any of the processes and sub-processes of electronic wallet based remittance may be implemented as computer-readable instructions stored on a computer-readable medium.

All of the above may be arranged in accordance with at least some embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

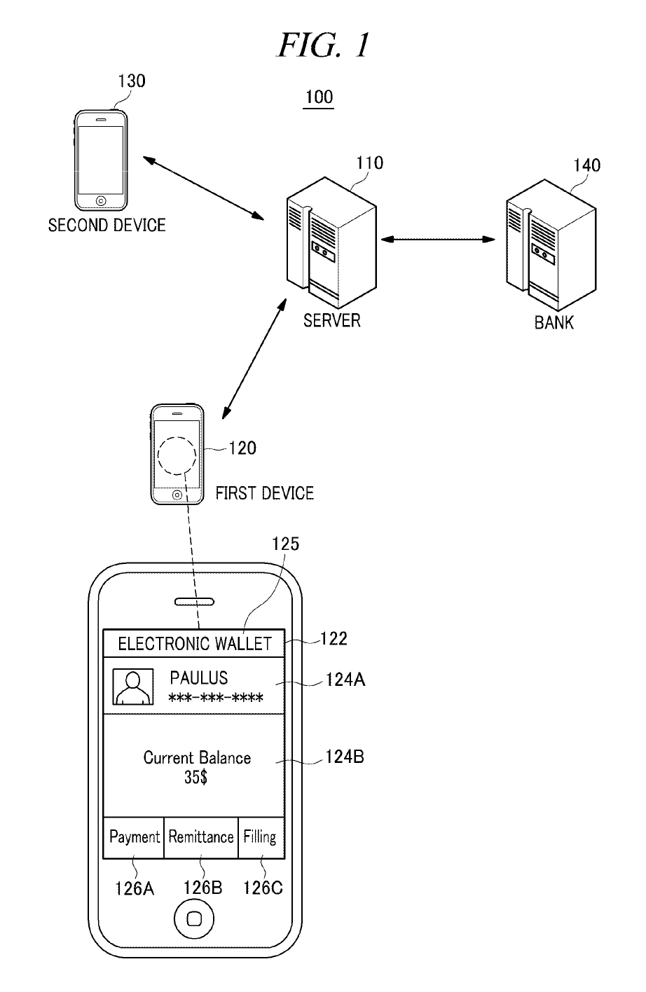

FIG. 1 shows an example system configuration 100 in which one or more embodiments of electronic wallet based remittance may be implemented, arranged in accordance with at least some embodiments described herein. As depicted in FIG. 1, system configuration 100 includes, at least, a server 110, a first device 120, a second device 130 and one or more bank servers 140 (operated by a bank or other financial institution; referred hereafter as “bank server 140” though not limited in quantity). At least one of server 110, first device 120, second device 130 and bank server 140 may be connected to each other via a wireless network or a wired network.

As referenced herein, “a first electronic wallet 122” may refer to an application, an instance of which may be hosted and executed on first device 120, to facilitate a remittance from first device 120, on behalf of a first user to whom a corresponding first virtual account has been generated, to a second user of second device 130, without accessing or otherwise referencing a bank account of the first user. For example, electronic wallet 122 may be downloaded onto first device 120 from virtual application market, such as the Apple™ App Store, the Google™ Google Play, etc. With electronic wallet 122 hosted thereon, first device 120 may transmit, to server 110 of a service provider for “an electronic wallet based remittance service”, a request to activate first electronic wallet 122. Further, when first device 120 receives, from server 110, data regarding issued first electronic wallet 122, first device 120 may activate the downloaded application as first electronic wallet 122 by using the received data regarding issued first electronic wallet 122. Subsequently, first device 120 may make a remittance from the first virtual account to a second virtual account corresponding to second device 130 or to a bank account of the second user by manipulating first electronic wallet 122.

As depicted in FIG. 1, first device 120 may be configured to display first electronic wallet 122 on a display panel 125. By way of non-limiting examples, first electronic wallet 122 may include a user interface with a first field 124A, a second field 124B, a “Payment” icon 126A, a “Remittance” icon 126B, and a “Filling” icon 126C. As referenced herein, first field 124A may be configured to display identification information for the first user of first device 120, such as an image, a user name, a first account identifier of the first virtual account corresponding to first electronic wallet 122, etc. Second field 124B may be configured to display a current balance corresponding to first electronic wallet 122 independently managed by server 110. Each of icons 126A, 126B and 126C may correspond to a predetermined command, respectively. For example, icon 126A may be clicked, selected, or otherwise activated to make a payment; and icon 126B may be clicked, selected, or otherwise activated to make a remittance; and icon 126C may be clicked, selected, or otherwise activated to replenish first electronic wallet 122 issued to the first user of first device 120.

Server 110 may be configured to issue first electronic wallet 122 to be hosted on first device 120 in response to a request to issue first electronic wallet 122 received from first device 120, and to match issued first electronic wallet 122 to the first account identifier of the first virtual account. Server 110 may be hosted by the service provider. As referenced herein, the first virtual account may be generated by bank server 140 in response to a request to generate the first virtual account transmitted to bank server 140 by server 110, and the first account identifier of the first virtual account may be transmitted to server 110 by bank server 140.

Similarly, the second electronic wallet, to be hosted on second device 130, may be a second instance of the electronic wallet application that is issued by server 110 in response to a request to issue the second electronic wallet transmitted to server 110 by second device 130.

Server 110 may be further configured to receive from first device 110 a remittance request to remit a remittance amount from first electronic wallet 122 to the second user. As referenced herein, the remittance request may include the remittance amount and an end device identifier for second device 140, such as a telephone number, a serial number, a Universal Subscriber Identity Module (USIM), an International Mobile Subscriber Identity (IMSI), a Globally Unique Temporary Identifier (GUTI), a Media Access Control (MAC) address, etc.

First device 120 and second device 130 may refer to at least one of a mobile phone, a smart phone, a portable device, a notebook, a personal computer or a personal communication terminal. Non-limiting examples of such devices may include PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminals.

First device 120 may be configured to transmit to server 110 the request to issue first electronic wallet 122. As referenced herein, the transmitted request to issue first electronic wallet 122 may also include the request to generate the first virtual account. Then, first device 120 may receive from server 110 a notification that first electronic wallet 122 has been issued and that the first virtual account has been generated with the first account identifier of the generated first virtual account. Alternatively, first device 120 may receive the notification that the first virtual account has been generated from bank server 140.

First device 120 may be further configured to receive input data, including the remittance amount, by the user input from the first user. Alternatively, first device 120 may receive the remittance amount as second device 140 beams the remittance amount to first device 120. Then, first device 120 may be further configured to transmit to server 110 the remittance request to remit the remittance amount including the remittance amount and the aforementioned end device identifier of second device 140. As referenced herein, the transmitted end device identifier of second device 140 may be used by server 110 to retrieve the second account identifier of the second virtual account corresponding to second device 140 to remit the remittance amount. First device 120 may be configured to receive from server 110 a notification indicating completion of remittance with a remittance slip. Alternatively, first device 120 may receive the notification indicating completion of payment with the remittance slip from, not server 110, but rather bank server 140. Of course first device 120 may receive the notification indicating completion of payment from server 110 and receive the remittance slip from bank server 140 respectively, or vice versa.

Second device 130 may receive from server 110 the request to accept the remittance amount into the second electronic wallet if the second electronic wallet has been issued. In this case, second device 130 may transmit to server 110 the approval of the request or the refusal of the request.

Second device 130 may receive from server 110 the notification that the remittance amount has been deposited into the virtual account of server 110 if the second electronic wallet has not been issued, and a request to select the bank account of the second user or the second electronic wallet to receive the remittance amount. If the second user wants to receive the remittance amount for the bank account of the second user, second device 130 may receive input data including an account identifier of the bank account of the second user by the second user through a user input and transmit to server 110 the received account identifier of the bank account of the second user. Alternatively, if the second user wants to receive the remittance amount for the second electronic wallet, second device 130 may transmit to server 110 the request to issue the second electronic wallet. Otherwise, second device 130 may transmit to server 110 a notification that the second user don't want to receive the remittance amount.

Bank server 140 may be configured to receive from server 110 the request to generate the first virtual account corresponding to first electronic wallet 122, and further, to generate the requested first virtual account. Bank server 140 may be configured to transmit the notification that the first virtual account has been generated to server 110 or first device 120. Similarly, bank server 140 may generate the second virtual account when bank server 140 receives from server 110 the request to generate the second virtual account corresponding to the second electronic wallet.

Bank server 140 may be further configured to receive from server 110 the request to deposit the remittance amount from the first virtual account to the virtual account of server 110 temporarily if the second electronic wallet has not been issued. In this case, bank server 140 may be further configured to receive from server 110 the request to remit the deposited remittance amount to the second virtual account corresponding to the second electronic wallet to be issued to second device 130 or the bank account of the second user.

If the second electronic wallet has been issued, bank server 140 may be further configured to receive from server 110 the request to remit the remittance amount from the first virtual account to the second virtual account.

Bank server 140 may further transmit to server 110 the notification indicating completion of remittance. In some embodiments, bank server 140 may be configured to transmit the notification indicating completion of remittance to first device 120 and/or second device 130.

Thus, FIG. 1 shows example system configuration 100 in which one or more embodiments of electronic wallet based remittance may be implemented.

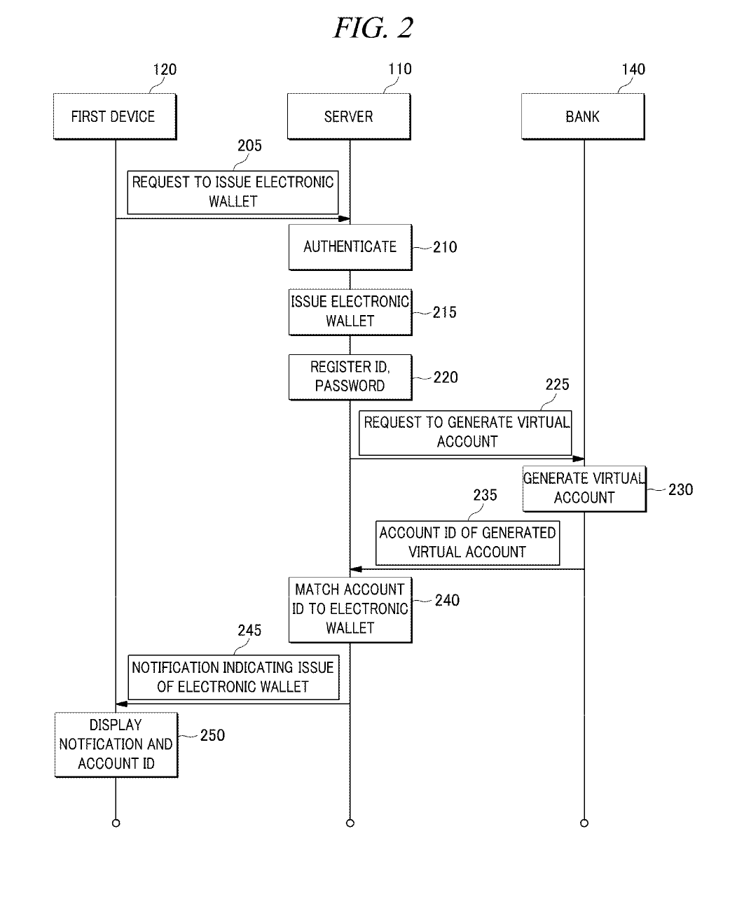

FIG. 2 shows an example processing flow of operations to implement at least portions of issuing a first electronic wallet 122 and to generate a corresponding first virtual account. The process in FIG. 2 may be implemented in system configuration 100 including server 110, first device 120 and bank server 140, as described with reference to FIG. 1. As referenced herein, the example processing flow of operations may apply to second device 130 like first device 120. An example process may include one or more operations, actions, or functions as illustrated by one or more blocks 205, 210, 215, 220, 225, 230, 235, 240, 245 and/or 250. Although illustrated as discrete blocks, various blocks may be divided into additional blocks, combined into fewer blocks, or eliminated, depending on the desired implementation. Processing may begin at block 205.

Block 205 (Transmit Request to Issue First Electronic Wallet 122) may refer to first device 120 transmitting, to server 110 of a service provider, a request to issue first electronic wallet 122 to be hosted on first device 120. As referenced herein, the request to issue first electronic wallet 122 may be transmitted to server 110 by first device 120, as a text/SMS, email, or even voice message via an instance of an application downloaded from a virtual application market, such as the Apple™ App Store, the Google™ Google Play, etc. As set forth above, the request to issue first electronic wallet 122 may also include a request to generate a first virtual account corresponding to first electronic wallet 122.

As referenced herein, the request to issue first electronic wallet 122 may include at least one of an identifier, a remittance password, a transaction password or a virtual account password. In some embodiments, the request to issue first electronic wallet 122 may include a unified password instead of the remittance password, the transaction password, and the virtual account password. That is, the union password may be used to complete a remittance, complete a transaction, and access the first virtual account instead of using, respectively, each of the remittance password, the transaction password, and the virtual account password. As further referenced herein, the identifier may include a user identifier and/or an end device identifier. Non-limiting examples of the user identifier may include at least one of a user name, an email address, an Internet Personal Identification Number (I-PIN), a social security number, a passport number, a driver's license number, etc. Further, non-limiting examples of the end device identifier may include at least one of a telephone number of first device 120, a serial number of first device 120, a Universal Subscriber Identity Module (USIM), an International Mobile Subscriber Identity (IMSI), a Globally Unique Temporary Identifier (GUTI), a Media Access Control (MAC) address, etc.

At least one of the remittance password, the transaction password or the virtual account password may be composed of at least a series of alphanumeric characters, numbers, and/or special characters. In some embodiments, the at least one of the remittance password, the transaction password or the virtual account password may include a certain gesture pattern on a touchscreen of the device, implemented using a user's finger, stylus, etc.

In some embodiments, first device 120 may be further configured to transmit, to server 110, a request to join an electronic wallet based remittance service to be provided for first electronic wallet 122. The request to join may include the request to issue first electronic wallet 122. As referenced herein, the request to join may include a login identifier and/or a login password for first electronic wallet 122. In this case, the user identifier or the end device identifier included in the request to issue may substitute for the login identifier included in the request to join. That is, server 110 may register the user identifier or the end device identifier included in the request to issue as the login identifier for first electronic wallet 122. Similarly, the remittance password, the transaction password, the virtual account password, or the unified password may substitute for the login password included in the request to join.

Thus, at block 205, first device 120 may transmit the request to issue first electronic wallet 122 when first device 120 receives a user input corresponding to the request to issue first electronic wallet 122 from a user of first device 120. Processing may proceed from block 205 to block 210.

Block 210 (Authenticate First Device and/or User Identifier) may refer to server 110 authenticating first device 120 before issuing first electronic wallet 122. By way of example, server 110 may generate authentication information, such as an authentication code, an authentication number, an authentication image showing certain digit and/or letter, etc., and transmit the generated authentication information to first device 120. The generated authentication information may be transmitted to first device 120, by server 110, as a form of an instant message, push message, text/SMS, etc. Server 110 may receive, from first device 120, test authentication information in response to the transmitted authentication information and determine whether the generated authentication information is identical to the received test authentication information. In some embodiments, block 210 may refer to server 110 authenticating the user identifier included in the request before issuing first electronic wallet 122. For example, server 110 may authenticate the user identifier by determining whether the at least one of Internet Personal Identification Number (I-PIN), social security number, passport number or driver's license number corresponds to the first user of first device 120. As referenced herein, the determining may be executed by an outside organization that manages personal security information. Processing may proceed from block 210 to block 215.

Block 215 (Issue First Electronic Wallet 122) may refer to server 110 issuing first electronic wallet 122 based on the transmitted request to issue first electronic wallet 122. Further, server 110 may configured to register issued first electronic wallet 122 in a memory of server 110. Processing may proceed from block 215 to block 220.

Block 220 (Register Identifier and/or Password) may refer to server 110 registering the received identifier and/or at least one of the aforementioned password, such as the remittance password, the transaction password or the virtual account password, with respect to registered first electronic wallet 122. As set forth above, the identifier may include the end device identifier or the user identifier. Processing may proceed from block 220 to block 225.

Block 225 (Transmit Request to Generate First Virtual Account) may refer to server 110 transmitting, to bank server 140, a request to generate the first virtual account corresponding to issued first electronic wallet 122. Alternatively, even if first electronic wallet 122 has not been issued, the request to generate the first virtual account may be transmitted to bank server 140 by server 110 when server 110 receives, from first device 120, the request to issue first electronic wallet 122 as block 205. As referenced herein, the request to generate the first virtual account may include at least one of the received user identifier, the received end device identifier, or information regarding issued first electronic wallet 122. Further, when bank server 140 receives the virtual account password, bank server 140 may register the received virtual account password with the generated first virtual account. Processing may proceed from block 225 to block 230.

Block 230 (Generate First Virtual Account) may refer to bank server 140 generating the first virtual account corresponding to issued first electronic wallet 122. In some embodiments, with respect to an issued single electronic wallet, bank server 140 may generate multiple virtual accounts, and each virtual account may be matched to a predefined usage, such as a utility fee, a health insurance premium, etc. In contrast, if a single user owns multiple end devices, a single virtual account may correspond to multiple electronic wallets. That is, the single virtual account may be shared with the multiple electronic wallets corresponding to the multiple end devices of the single user. Processing may proceed from block 230 to block 235.

Block 235 (Transmit First Account Identifier of Generated First Virtual Account) may refer to bank server 140 transmitting to server 110 a first account identifier of the generated first virtual account, such as an account number, etc. Bank server 140 may further transmit, to server 110, a notification that the first virtual account has been generated. Processing may proceed from block 235 to block 240.

Block 240 (Match First Account Identifier to First Electronic Wallet 122) may refer to server 110 matching the received first account identifier of the generated first virtual account to issued first electronic wallet 122. Thus, server 110 may manage both first electronic wallet 122 and the first account identifier of the first virtual account together. For example, when server 110 receives from first device 120 a request including a remittance amount and an identifier of second device 130, server 110 may retrieve the first account identifier of the generated first virtual account. Further, server 110 may utilize the retrieved first account identifier of the first virtual account to generate a request to deposit the remittance amount or a request to remit the remittance amount. Processing may proceed from block 240 to block 245.

Block 245 (Transmit Notification indicating Issue of First Electronic Wallet 122) may refer to server 110 transmitting a notification that first electronic wallet 122 has been issued to first device 120. Block 245 may refer to server 110 further transmitting a notification that the first virtual account has been generated with the notification that first electronic wallet 122 has been issued to first device 120. As referenced herein, the notification that the first virtual account has been generated may include the first account identifier of the first virtual account. In some embodiments, server 110 may transmit to first device 120 data regarding issued first electronic wallet 122 to activate the downloaded application as first electronic wallet 122. Processing may proceed from block 245 to block 250.

Block 250 (Display Notification and First Account Identifier) may refer to first device 120 displaying at least one of the notification that first electronic wallet 122 has been issued or the notification that the first virtual account has been generated with the first account identifier of the first virtual account on a display panel 125 installed on or coupled to first device 120. Thus, the first user of first device 120 may be informed that requested first electronic wallet 122 has been issued and/or that the first virtual account has been generated successfully. In some embodiments, first device 120 may receive from server 110 the data regarding issued first electronic wallet 122, and activate the downloaded application as first electronic wallet 122 by using the received data regarding first electronic wallet 122.

Thus, FIG. 2 shows an example processing flow of operations to implement at least portions of issuing first electronic wallet 122 and to generate a corresponding first virtual account.

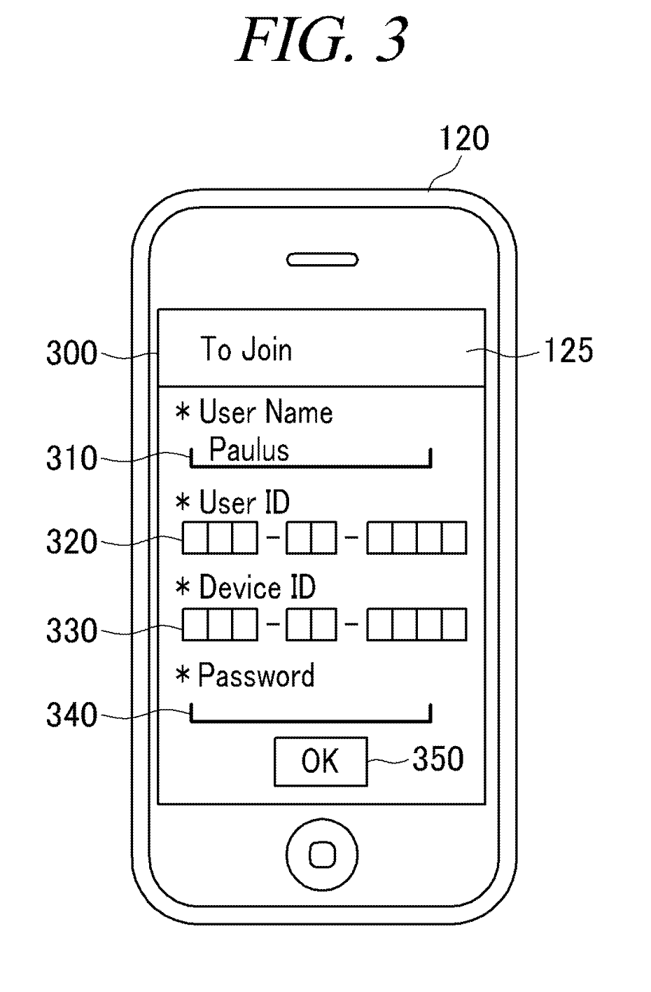

FIG. 3 shows an illustrative example of a first device 120 in which one or more embodiments of electronic wallet based payment may be implemented. First device 120, which is described above with regard to FIG. 1, may be configured to display a user interface 300 for joining an electronic wallet based transaction service on a display panel 125 installed on first device 120. First device 120 may be configured to display user interface 300 when receiving a user input with respect to a request to issue first electronic wallet 122.

By way of example, as depicted in FIG. 3, user interface 300 may include input fields for a user name 310, a user identifier 320, an end device identifier 330, a password 340, and an “OK” icon 350. As referenced herein, the password may be a remittance password. In some embodiments, user interface 300 may further include input fields for a transaction password, a virtual account password, etc.

As referenced herein, non-limiting examples of the user identifier to be input into input field 320 may include at least one of an email address, an Internet Personal Identification Number (I-PIN), a social security number, a passport number, a driver's license number, etc. As further referenced herein, non-limiting examples of the end device identifier to be input to input field 330 may include at least one of a telephone number of first device 120, a serial number of first device 120, an International Mobile Subscriber Identity (IMSI), a Globally Unique Temporary Identifier (GUTI), a Media Access Control (MAC) address, etc. When the first user of first device 120 inputs the user name, the user identifier, the end device identifier and the password respectively on each input field and click or otherwise activate “OK” icon 350, first device 120 may transmit to server 110 a request to issue first electronic wallet 122 including the input information. As referenced herein, “OK” icon 350 may refer to a UI button that may be clicked or activated to indicate a user selection, and may otherwise be labeled as “enter,” “confirm,” etc.

In some embodiments, user interface 300 may further include at least one input field for a login identifier, a login password, or a virtual account password. In some other embodiments, user interface 300 may further include an icon corresponding to a request for authentication information and an input field for authentication information. For example, when the first user of first device 120 clicks or otherwise activates the icon to transmit a request for authentication information to server 110, end device 120 may transmit the request for authentication information to server 110 and receive the authentication information from server 110. When the first user inputs the received authentication information correctly on the field for authentication information, server 110 may authenticate end device 120. In still some other embodiments, user interface 300 may further include at least one icon that may be clicked or otherwise activated to transmit a request to confirm that at least one of input information, such as the user name, the user identifier, the end device identifier, the remittance password, the transaction password, the virtual account password, the login identifier, the login password, etc., is proper.

Thus, FIG. 3 shows an illustrative example of a first device 120 in which one or more embodiments of electronic wallet based payment may be implemented.

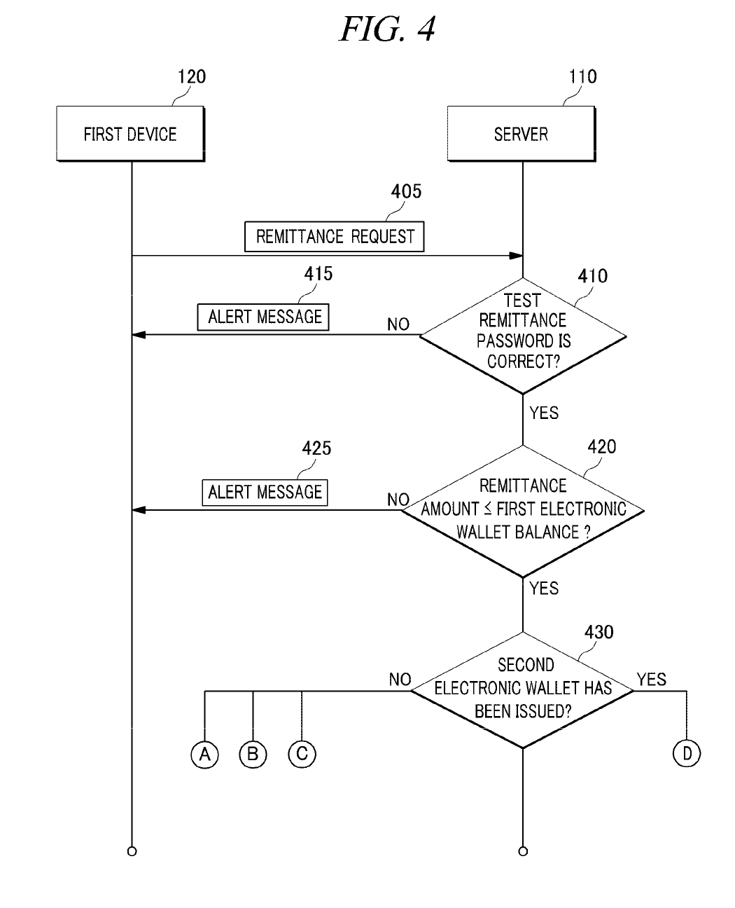

FIG. 4 shows an example processing flow of operations for implementing at least portions of requesting for remittance utilizing a first electronic wallet 122. The process in FIG. 4 may be implemented in system configuration 100 including server 110 and first device 120, as described with reference to FIG. 1. An example process may include one or more operations, actions, or functions as illustrated by one or more blocks 405, 410, 415, 420, 425 and/or 430. Although illustrated as discrete blocks, various blocks may be divided into additional blocks, combined into fewer blocks, or eliminated, depending on the desired implementation. Processing may begin at block 405.

Block 405 (Transmit Remittance Request) may refer to first device 120 transmitting, to server 110, a remittance request including a remittance amount, a first device identifier of first device 120, a second device identifier of second device 130, and a test remittance password. As set forth above, non-limiting examples of an end device identifier, which is included in the first device identifier and the second device identifier, may include one or more of a telephone number, a serial number, a Universal Subscriber Identity Module (USIM), an International Mobile Subscriber Identity (MI), a Globally Unique Temporary Identifier (GUTI), a Media Access Control (MAC) address, etc.

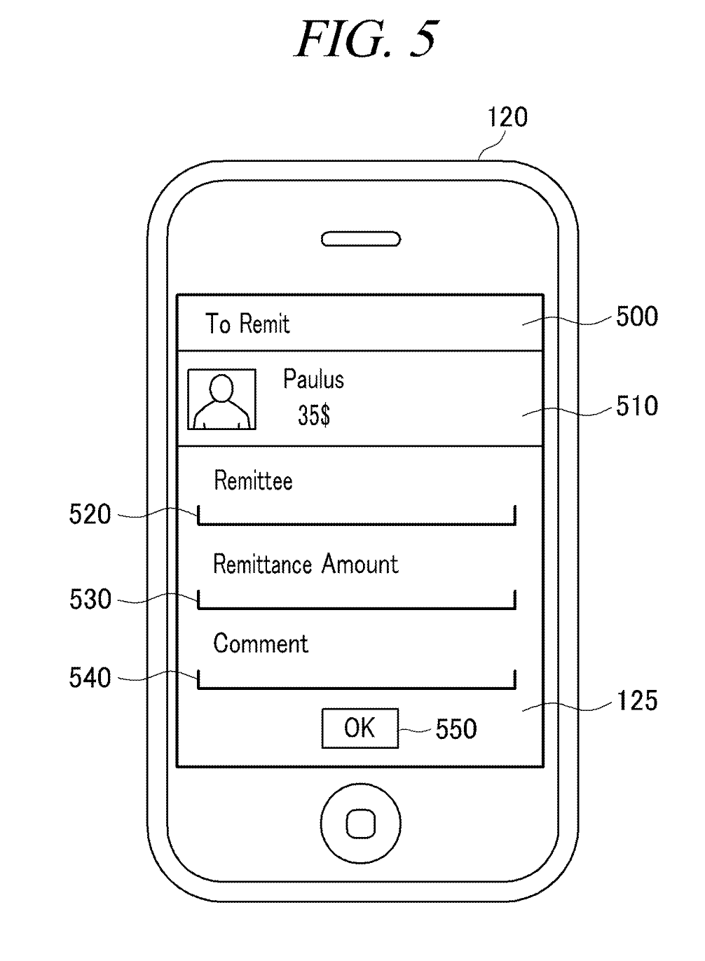

As referenced herein, the remittance amount may be input into a user interface (UI) field by a first user as depicted and described with reference to FIG. 5.

FIG. 5 shows a user interface for making a remittance displayed on a first device 120, in which one or more embodiments of electronic wallet based remittance may be implemented. First device 120, which is described above with regard to FIG. 1, may be configured to display a user interface 500 on a display panel 125 of first device 120 to make a remittance. First device 120 may be configured to display user interface 500 when receiving a user input with respect to a request to make a remittance.

By way of example, as depicted in FIG. 5, user interface 500 may include a first field 510, a second device identifier field 520, a remittance amount field 530, a comment field 540 to show a message to be sent to a remittee, and an “OK” icon 550.

First field 510 may include at least one of an image, a user name, or a current balance corresponding to first electronic wallet 122. First field 510 may further include at least one of a login identifier, a telephone number of first device 120 or an account identifier of a first virtual account.

An item to be input onto second device identifier field 520 may include the second device identifier of second device 130. By way of example, a first user may input a telephone number of second device 130 onto second device identifier field 520. In some embodiments, the telephone number of second device 130 may be retrieved from an address book stored in a memory of first device 120 and input to second device identifier field 520. Since server 110 manages an electronic wallet to be hosted on an end device by matching the electronic wallet to an end device identifier of the end device, the second device identifier of second device 130 that is to be transmitted to server 110 may be utilized to determine whether a second electronic wallet has been issued at server 110.

An item to be input onto remittance amount field 530 may include the remittance to be remitted to a second user as the remittee. As referenced herein, the remittance amount may be remitted to a bank account of the second user or to a second virtual account corresponding to the second electronic wallet of the second user.

An item to be input onto comment field 540 may include a message to be sent to the remittee. As referenced herein, the message may be transmitted to second device 130 as a form of an instant message, push message, text/SMS/MMS, e-mail, even voice message, etc., and further, the message may be displayed on a display panel installed on second device 130 when completing the remittance.

When the first user inputs the second device identifier, the remittance amount, and the message onto field 520 to 540 respectively, and clicks, selects, or otherwise activates “OK” icon 550, first device 120 may transmit to server 110 a remittance request.

As referenced herein, user interface 500 may further include an input field for a remittance password. Otherwise, when the first user clicks, selects, or otherwise activates “OK” icon 550, a user interface for inputting the remittance password may be displayed on display panel 125 installed on first device 120. In some embodiments, when the first user clicks, selects, or otherwise activates “OK” icon 550, first device 120 may receive from server 110 an authenticate information, such as an authentication code, an authentication number, an authentication image showing certain digit and/or letter, etc., generated by server 110 as a form of an instant message, push message, text/SMS, etc. Then, a user interface for inputting test authentication information may be displayed on display panel 125.

Thus, FIG. 5 shows a user interface for making a remittance displayed on a first device 120 in which one or more embodiments of electronic wallet based remittance may be implemented.

Referring again to FIG. 4, in some embodiments, the remittance amount may be transmitted by beaming the remittance amount from second device 130 to first device 120. Processing may proceed from block 405 to block 410.

Block 410 (Determine whether Test Remittance Password is Correct) may refer to server 110 determining whether the received test remittance password is correct or not by comparing the received test remittance password to a remittance password stored in a memory of server 110. Processing may proceed from block 410 to block 415 or block 420 based on a result of the determination. That is, if the test remittance password is not correct, processing may proceed from block 410 to block 415; if the test remittance password is correct, processing may proceed from block 410 to block 420.

Block 415 (Transmit Alert Message) may refer to server 110 transmitting, to first device 120, a notification or alert that the test remittance password is not correct. In this case, first device 120 may display the received notification, and provide the first user a chance to input a new test remittance password.

Block 420 (Determine whether Remittance Amount is Same or Less than Current Balance corresponding to First Electronic wallet 122) may refer to server 110 determining whether the remittance amount is equal to or less than a current balance corresponding to first electronic wallet 122. As referenced herein, the current balance corresponding to first electronic wallet 122 may be independently managed by server 110 and be retrieved from the memory of server 110 by using the received first device identifier. Alternatively, server 110 may receive, from bank server 140, a current balance of a first virtual account independently managed by bank server 140, then update the current balance corresponding to first electronic wallet 122 to be equal to the current balance of the first virtual account. If the remittance amount exceeds the current balance corresponding to first electronic wallet 122, processing may proceed from block 420 to block 425; if the remittance amount is equal to or less than the current balance corresponding to first electronic wallet 122, processing may proceed from block 420 to block 430.

Block 425 (Transmit Alert Message) may refer to server 110 transmitting, to first device 120, a notification or alert that the remittance amount exceeds the current balance corresponding to first electronic wallet 122. In this case, first device 120 may display the received notification and then display a user interface field to input an additional amount of funds or purchase credits into first electronic wallet 122.

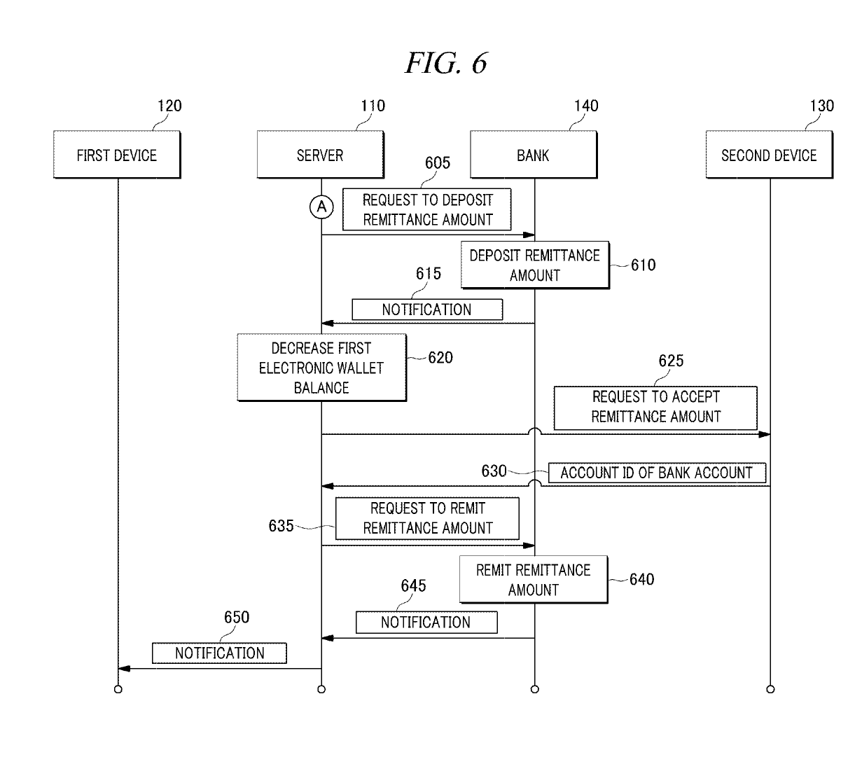

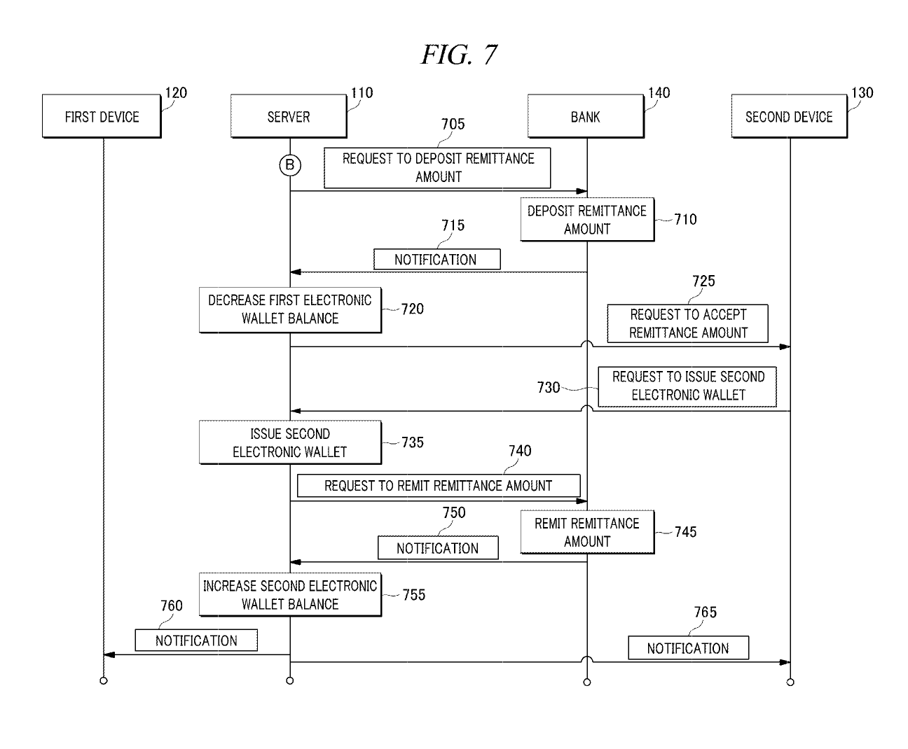

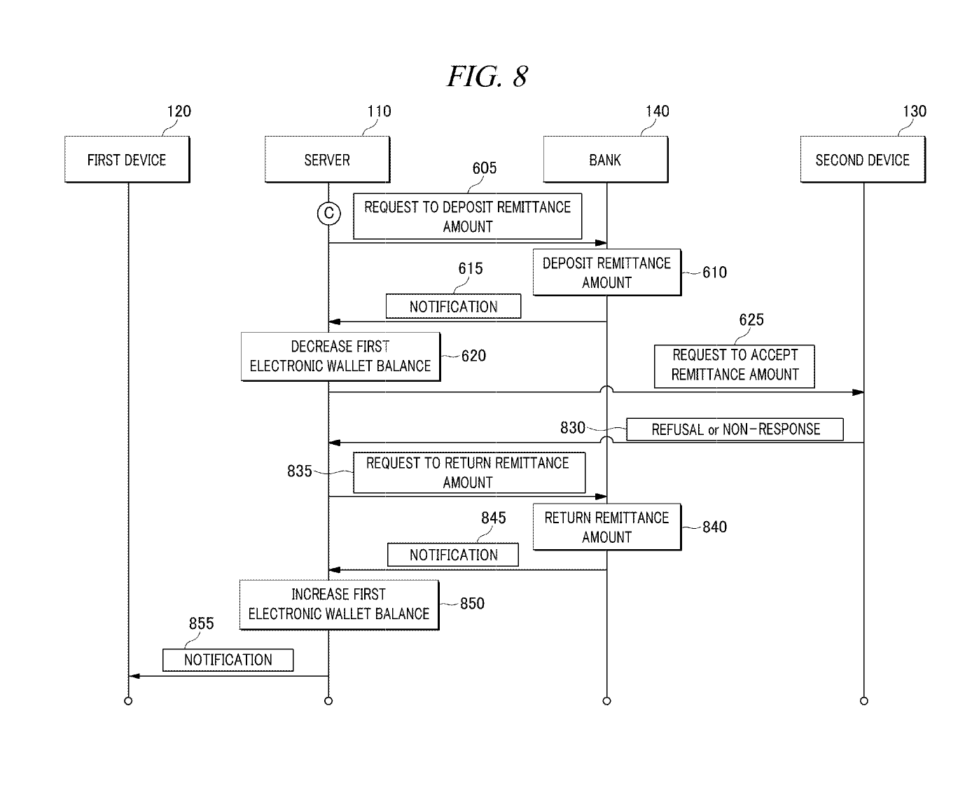

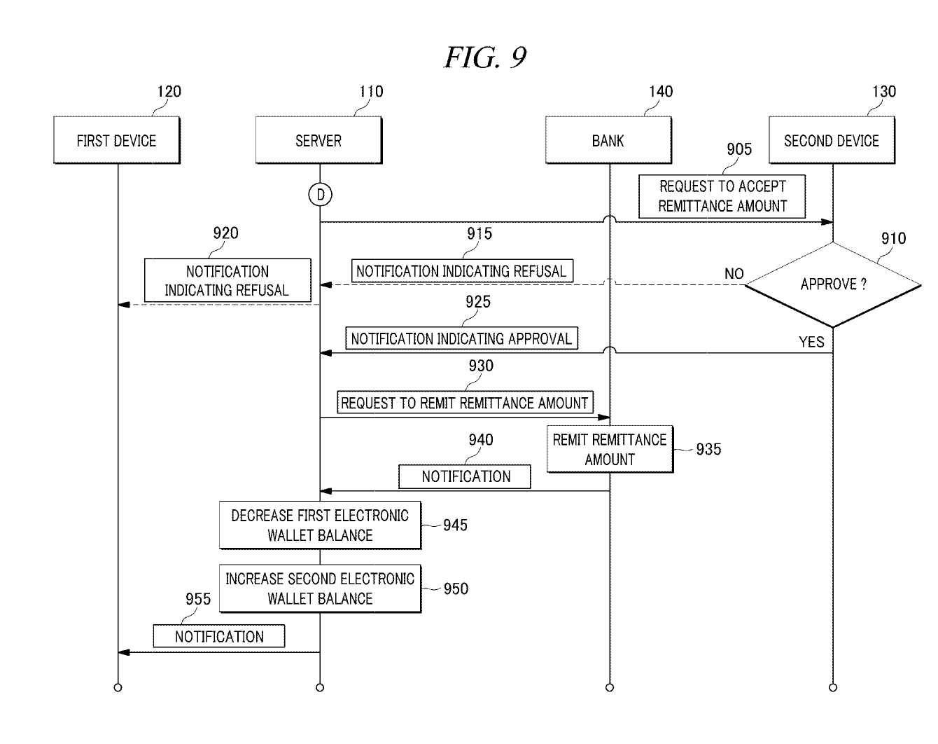

Block 430 (Determine whether Second Electronic Wallet has been Issued) may refer to server 110 determining whether a second electronic wallet has been issued to second device 130 by using the received second device identifier. For example, server 110 may search the second electronic wallet corresponding to the received second device identifier from the memory in order to determine whether the second electronic wallet has been issued. If the second electronic wallet has not been issued, processing may proceed from block 430 to block 605 as depicted and described with reference to FIG. 6, block 705 as depicted and described with reference to FIG. 7, or block 805 as depicted and described with reference to FIG. 8. For example, if a second user of second device 130 wants to receive the remittance amount into a bank account of the second user, processing may proceed to block 605; if the second user wants to receive the remittance amount into a second electronic wallet to be hosted on second device 130, processing may proceed to block 705; if the second user don't want to receive the remittance amount, processing may proceed from block 430 to block 805. If the second electronic wallet has been issued, processing may proceed to block 905 as depicted and described with reference to FIG. 9.

Thus, FIG. 4 shows an example processing flow of operations for implementing at least portions of requesting for remittance utilizing a first electronic wallet 122.

FIG. 6 shows an example processing flow of operations for implementing at least portions of completing a remittance utilizing a first electronic wallet 122. The process in FIG. 6 may be implemented in system configuration 100 including server 110, first device 120, second device 130 and bank server 140, as described with reference to FIG. 1. An example process may include one or more operations, actions, or functions as illustrated by one or more blocks 605, 610, 615, 620, 625, 630, 635, 640, 645, 650 and/or 655. Although illustrated as discrete blocks, various blocks may be divided into additional blocks, combined into fewer blocks, or eliminated, depending on the desired implementation. As depicted in FIG. 4, processing may proceed from block 430 to block 605 if a second electronic wallet has not been issued and a second user of second device 130 wants to receive the remittance amount into a bank account of the second user.

Block 605 (Transmit Request to Deposit Remittance Amount) may refer to server 110 of a service provider transmitting, to bank server 140, a request to deposit a remittance amount from a first virtual account corresponding to first electronic wallet 122 to a virtual account corresponding to server 110. As referenced herein, the request to deposit may include an account identifier of the first virtual account, an account identifier of the virtual account corresponding to server 110 and the remittance amount. For example, first device 120 may retrieve the account identifier of the first virtual account by using a first device identifier included in a remittance request. Processing may proceed from block 605 to block 610.

Block 610 (Deposit Remittance Amount) may refer to bank server 140 depositing the remittance amount from the first virtual account to the virtual account corresponding to server 110, temporarily. Processing may proceed from block 610 to block 615.

Block 615 (Transmit Notification indicating Completion of Deposit) may refer to bank server 140 transmitting to server 110 a notification indicating completion of deposit of the remittance amount. Processing may proceed from block 615 to block 620.

Block 620 (Decrease Current Balance corresponding to First Electronic Wallet 122) may refer to server 110 decreasing a current balance corresponding to first electronic wallet 122 by the deposited remittance amount. Alternatively, server 110 may receive a current balance of the first virtual account from bank server 140, and then adjust the current balance corresponding to first electronic wallet 122 to equal the received current balance of the first virtual account instead of decreasing the current balance corresponding to first electronic wallet 122 by the deposited remittance amount. Therefore, the current balance corresponding to first electronic wallet 122 may be synchronized with the current balance of the first virtual account. Processing may proceed from block 620 to block 625.

Block 625 (Transmit Request to Accept Remittance Amount) may refer to bank server 140 transmitting, to second device 130, a request to accept the deposited remittance amount. For example, bank server 140 may transmit, to second device 130, a request to accept the deposited remittance amount. Processing may proceed from block 625 to block 630.

Block 630 (Transmit Account Identifier of Bank Account) may refer to second device 130 transmitting to server 110 an account identifier of a bank account of a second user, if the second user wants to receive the deposited remittance amount into the bank account of the second user. In some embodiments, second device 130 may transmit, to server 110, a request to remit the deposited remittance amount including the account identifier of the bank account of the second user. Processing may proceed from block 630 to block 635.

Block 635 (Transmit Request to Remit Remittance Amount) may refer to server 110 transmitting, to bank server 140, a request to remit the deposited remittance amount to the bank account of the second user. As referenced herein, the request to remit the deposited remittance amount may include the account identifier of the virtual account corresponding to server 110, the received account identifier of the bank account of the second user, and/or the remittance amount. Processing may proceed from block 635 to block 640.

Block 640 (Remit Remittance Amount) may refer to bank server 140 remitting the deposited remittance amount from the virtual account corresponding to server 110 to the bank account of the second user by using both the received account identifier of the virtual account corresponding to server 110 and the received account identifier of the bank account of the second user. Processing may proceed from block 640 to block 645.

Block 645 (Transmit Notification indicating Completion of Remittance) may refer to bank server 140 transmitting to server 110 a notification indicating completion of remittance. As referenced herein, the notification indicating completion of remittance may include a remittance slip showing specific information for the remittance. Processing may proceed from block 645 to block 650.

Block 650 (Transmit Notification indicating Completion of Remittance) may refer to server 110 transmitting, to first device 120, the notification indicating completion of remittance. Server 110 may further transmit, to second device 130, the notification indicating completion of remittance. As set forth above, the notification indicating completion of remittance may include the remittance slip. The remittance slip may include the current balance corresponding to first electronic wallet 122 independently managed by server 110. Further, first device 120 may display the received notification indicating the completion of remittance with the remittance slip on display panel 125. Thus, the first user of first device 120 may be informed that the requested remittance has been completed and the requested remittance amount has been remitted from the first virtual account to the bank account of the second user. Processing may proceed from block 650 to block 655.

Block 655 (Transmit Notification indicating Completion of Remittance) may refer to server 110 transmitting to second device 130 the notification indicating completion of remittance. As referenced herein, the notification indicating completion of remittance may include a current balance of the bank account of the second user. Further, second device 130 may display the received notification indicating the completion of remittance with the current balance of the bank account of the second user on a display panel installed on or coupled to second device 130. Thus, the second user of second device 130 may be informed that the requested remittance has been completed and that the requested remittance amount has been remitted from the first virtual account to the bank account of the second user.

Thus, FIG. 6 shows an example processing flow of operations for implementing at least portions of completing a remittance utilizing a first electronic wallet 122.

FIG. 7 shows yet another example processing flow of operations for implementing at least portions of completing a remittance utilizing a first electronic wallet 122. The process in FIG. 7 may be implemented in system configuration 100 including server 110, first device 120, second device 130 and bank server 140, as described with reference to FIG. 1. An example process may include one or more operations, actions, or functions as illustrated by one or more blocks 705, 710, 715, 720, 725, 730, 735, 740, 745, 750, 755, 760 and/or 765. Although illustrated as discrete blocks, various blocks may be divided into additional blocks, combined into fewer blocks, or eliminated, depending on the desired implementation. As depicted in FIG. 4, processing may proceed from block 430 to block 705 if a second electronic wallet has not been issued and a second user of second device 130 wants to receive the remittance amount into a second electronic wallet to be hosted on second device 130.

Here, since the function and operation of the blocks 705, 710, 715, 720 and 725 are similar to those of the blocks 605, 610, 615, 620 and 625 discussed above in FIG. 6, redundant description thereof will be omitted herein.

Block 730 (Transmit Request to Issue Second Electronic Wallet) may refer to second device 130 transmitting, to server 110 of a service provider, a request to issue a second electronic wallet to be hosted on second device 130 if a second user wants to receive a deposited remittance amount into the second electronic wallet or a second virtual account corresponding to the second electronic wallet. As set forth above, the request to issue the second electronic wallet may include at least one of a user identifier, an end device identifier, a remittance password, a transaction password, or a virtual account password. Processing may proceed from block 730 to block 735.

Block 735 (Issue Second Electronic Wallet) may refer to server 110 issuing the requested second electronic wallet to second device 130. Further, with respect to the issued second electronic wallet, server 110 may transmit, to bank server 140, a request to generate the second virtual account; and receive, from bank server 140, a notification that the second virtual account has been generated with a second account identifier of the generated second virtual account. As referenced herein, the second electronic wallet may refer to an application that may be hosted and executed on second device 130 as first electronic wallet 122. In this case, server 110 may transmit to second device 130 a notification that the second electronic wallet has been issued and that the second virtual account has been generated. Processing may proceed from block 735 to block 740.

Block 740 (Transmit Request to Remit Remittance Amount) may refer to server 110 transmitting, to bank server 140, a request to remit the deposited remittance amount to the second virtual account. As referenced herein, the request to remit the deposited remittance amount may include an account identifier of a virtual account corresponding to server 110, the received second account identifier of the second virtual account, and the remittance amount. Processing may proceed from block 740 to block 745.

Block 745 (Remit Remittance Amount) may refer to bank server 140 remitting the deposited remittance amount from the virtual account corresponding to server 110 to the second virtual account by using the received account identifier of the virtual account corresponding to server 110 and the received second account identifier of the second virtual account. Processing may proceed from block 745 to block 750.

Block 750 (Transmit Notification indicating Completion of Remittance) may refer to bank server 140 transmitting, to server 110, a notification indicating completion of remittance. As referenced herein, the notification indicating completion of remittance may include a remittance slip showing specific information for the remittance. Processing may proceed from block 750 to block 755.

Block 755 (Increase Current Balance corresponding to Second Electronic Wallet) may refer to server 110 increasing a current balance corresponding to the second electronic wallet by the remitted remittance amount. Alternatively, server 110 may receive a current balance of the second virtual account from bank server 140, and then adjust the current balance corresponding to the second electronic wallet to equal the received current balance of the second virtual account instead of increasing the current balance corresponding to the second electronic wallet by the remitted remittance amount. Therefore, the current balance corresponding to the second electronic wallet may be synchronized with the current balance of the second virtual account. Processing may proceed from block 755 to block 760.

Block 760 (Transmit Notification indicating Completion of Remittance) may refer to server 110 transmitting, to first device 120, the notification indicating completion of remittance. As set forth above, the notification indicating completion of remittance may include the remittance slip. The remittance slip may include the current balance corresponding to first electronic wallet 122 independently managed by server 110. Further, first device 120 may display the received notification indicating the completion of remittance with the remittance slip on display panel 125. Thus, the first user of first device 120 may be informed that the requested remittance has been completed and that the requested remittance amount has been remitted from the first virtual account to the bank account of the second user. Processing may proceed from block 760 to block 765.

Block 765 (Transmit Notification indicating Completion of Remittance) may refer to server 110 transmitting to second device 130 the notification indicating completion of remittance. As referenced herein, the notification indicating completion of remittance may include the current balance corresponding to the second electronic wallet independently managed by server 110. Further, second device 130 may display the received notification indicating the completion of remittance with the current balance corresponding to the second electronic wallet on a display panel installed on or coupled to second device 130. Thus, the second user of second device 130 may be informed that the requested remittance has been completed and that the requested remittance amount has been remitted from the first virtual account to the second virtual account.

Thus, FIG. 7 shows yet another example processing flow of operations for implementing at least portions of completing a remittance utilizing a first electronic wallet 122.

FIG. 8 shows yet further example processing flow of operations for implementing at least portions of completing a remittance utilizing a first electronic wallet 122. The process in FIG. 8 may be implemented in system configuration 100 including server 110, first device 120, second device 130 and bank server 140, as described with reference to FIG. 1. An example process may include one or more operations, actions, or functions as illustrated by one or more blocks 805, 810, 815, 820, 825, 830, 835, 840, 845, 850 and/or 855. Although illustrated as discrete blocks, various blocks may be divided into additional blocks, combined into fewer blocks, or eliminated, depending on the desired implementation. As depicted in FIG. 4, processing may proceed from block 430 to block 805 if a second electronic wallet has not been issued.

Here, since the function and operation of the blocks 805, 810, 815, 820 and 825 are similar to those of the blocks 605, 610, 615, 620 and 625 discussed above in FIG. 6, redundant description thereof will be omitted herein.

Block 830 (Transmit Refusal or Non-Response) may refer to second device 130 transmitting, to server 110 of a service provider, a refusal for a request to accept a remittance amount at block 825 if a second user don't want to receive a deposited remittance amount. Otherwise, second device 130 may respond to the request to accept the remittance amount within a predetermined time. In this case, a non-response by second device 130 may be regarded as the refusal of the request to accept the remittance amount. Processing may proceed from block 830 to block 835.

Block 835 (Transmit Request to Return Remittance Amount) may refer to server 110 transmitting, to bank server 140, a request to return the deposited remittance amount to a first virtual account corresponding to first electronic wallet 122. As referenced herein, the request to return the deposited remittance amount may include an account identifier of a virtual account corresponding to server 110, a first account identifier of the first virtual account retrieved from a memory of server 110, and/or the deposited remittance amount to be returned. Processing may proceed from block 835 to block 840.

Block 840 (Return Remittance Amount) may refer to bank server 140 returning the deposited remittance amount from the virtual account corresponding to server 110 to the first virtual account by using the received account identifier of the virtual account corresponding to server 110, the received first account identifier of the first virtual account. Processing may proceed from block 840 to block 845.

Block 845 (Transmit Notification indicating Completion of Returning) may refer to bank server 140 transmitting, to server 110, a notification indicating completion of returning. Processing may proceed from block 845 to block 850.

Block 850 (Increase Current Balance corresponding to First Electronic Wallet 122) may refer to server 110 increasing a current balance corresponding to first electronic wallet 122 by the returned remittance amount. Alternatively, server 110 may receive a current balance of the first virtual account from bank server 140, and then adjust the current balance corresponding to first electronic wallet 122 to equal the received current balance of the first virtual account instead of increasing the current balance corresponding to first electronic wallet 122 by the returned remittance amount. Therefore, the current balance corresponding to first electronic wallet 122 may be synchronized with the current balance of the first virtual account. Processing may proceed from block 850 to block 855.

Block 855 (Transmit Notification indicating Completion of Returning) may refer to server 110 transmitting, to first device 120, the notification indicating completion of returning the remittance amount from the virtual account corresponding to server 110 to the first virtual account corresponding to first electronic wallet 122. The notification indicating completion of returning may include the current balance corresponding to first electronic wallet 122 independently managed by server 110. Further, first device 120 may display the received notification indicating the completion of the return of the remittance amount, with the current balance corresponding to first electronic wallet 122 on display panel 125. Thus, the first user of first device 120 may be informed that the requested returning has been completed.

Thus, FIG. 8 shows yet further example processing flow of operations for implementing at least portions of completing a remittance utilizing a first electronic wallet 122.

FIG. 9 shows still another example processing flow of operations for implementing at least portions of refusing a remittance utilizing a first electronic wallet 122. The process in FIG. 9 may be implemented in system configuration 100 including server 110, first device 120, second device 130 and bank server 140, as described with reference to FIG. 1. An example process may include one or more operations, actions, or functions as illustrated by one or more blocks 905, 910, 915, 920, 925, 930, 935, 940, 945, 950, 955 and/or 960. Although illustrated as discrete blocks, various blocks may be divided into additional blocks, combined into fewer blocks, or eliminated, depending on the desired implementation. As depicted in FIG. 4, processing may proceed from block 430 to block 905 if a second electronic wallet has been issued.

Block 905 (Transmit Request to Accept Remittance Amount) may refer to server 110 of a service provider transmitting a request to accept a remittance amount. That is, server 110 may transmit, to second device 130, a request for confirmation to accept the remittance amount. Processing may proceed from block 905 to block 910.

Block 910 (Determine Whether Second Device 130 Approve Request to Accept Remittance Amount) may refer to second device 130 determining whether second device 130 has affirmed the request to accept the remittance amount or not. If the second device 130 refuses the request to accept the remittance amount, processing may proceed from block 910 to block 915; if the second device 130 affirms the request to accept the remittance amount, processing may proceed from block 910 to block 925.

Block 915 (Transmit Notification indicating Refusal) may refer to second device 130 transmitting, to server 110, a notification indicating refusal of the request to accept the remittance amount. Processing may proceed from block 915 to block 920.

Block 920 (Transmit Notification indicating Refusal) may refer to server 110 transmitting, to first device 120, the notification indicating a refusal of the request to accept the remittance amount. Server 110 may display the notification indicating the refusal on display panel 125 to inform that a second user does not want to receive the remittance amount or the second user didn't make any response.

Block 925 (Transmit Notification indicating Approval) may refer to second device 130 transmitting, to server 110, a notification indicating approval of the request to accept the remittance amount. Processing may proceed from block 925 to block 930.

Block 930 (Transmit Request to Remit Remittance Amount) may refer to server 110 transmitting, to bank server 140, a request to remit the remittance amount from a first virtual account corresponding to first electronic wallet 122 to a second virtual account corresponding to a second electronic wallet. As referenced herein, the request to remit may include the remittance amount, a first account identifier of the first virtual account, and/or a second account identifier of the second virtual account. Processing may proceed from block 930 to block 935.

Block 935 (Remit Remittance Amount) may refer to bank server 140 remitting the remittance amount from the first virtual account to the second virtual account by using the remittance amount, the first account identifier and the second account identifier included in the request to remit. Processing may proceed from block 935 to block 940.

Block 940 (Transmit Notification indicating Completion of Remittance) may refer to bank server 140 transmitting, to server 110, a notification indicating completion of remittance. As referenced herein, the notification indicating completion of remittance may include a remittance slip showing specific information for the remittance. Processing may proceed from block 940 to block 945.

Block 945 (Decrease Current Balance corresponding to First Electronic Wallet 122) may refer to server 110 decreasing a current balance corresponding to first electronic wallet 122 by the remitted remittance amount. Alternatively, server 110 may receive a current balance of the first virtual account from bank server 140, and then adjust the current balance corresponding to first electronic wallet 122 to equal the received current balance of the first virtual account instead of decreasing the current balance corresponding to first electronic wallet 122 by the remitted remittance amount. Therefore, the current balance corresponding to first electronic wallet 122 may be synchronized with the current balance of the first virtual account. Processing may proceed from block 945 to block 950.

Block 950 (Increase Current Balance corresponding to Second Electronic Wallet) may refer to server 110 increasing a current balance corresponding to the second electronic wallet by the remitted remittance amount. Alternatively, server 110 may receive a current balance of the second virtual account from bank server 140, and then adjust the current balance corresponding to the second electronic wallet to equal the received current balance of the second virtual account instead of increasing the current balance corresponding to the second electronic wallet by the remitted remittance amount. Therefore, the current balance corresponding to the second electronic wallet may be synchronized with the current balance of the second virtual account. Processing may proceed from block 950 to block 955.

Block 955 (Transmit Notification indicating Completion of Remittance) may refer to server 110 transmitting, to first device 120, the notification indicating completion of remittance. As set forth above, the notification indicating completion of remittance may include the remittance slip. The remittance slip may include the current balance corresponding to first electronic wallet 122 independently managed by server 110. Further, first device 120 may display the received notification indicating the completion of remittance with the remittance slip on display panel 125. Thus, the first user of first device 120 may be informed that the requested remittance has been completed and that the requested remittance amount has been remitted from the first virtual account to the bank account of the second user. Processing may proceed from block 955 to block 960.

Block 960 (Transmit Notification indicating Completion of Remittance) may refer to server 110 transmitting to second device 130 the notification indicating completion of remittance. As referenced herein, the notification indicating completion of remittance may include the current balance corresponding to the second electronic wallet independently managed by server 110. Further, second device 130 may display the received notification indicating the completion of remittance with the current balance corresponding to the second electronic wallet on a display panel installed on or coupled to second device 130. Thus, the second user of second device 130 may be informed that the requested remittance has been completed and that the requested remittance amount has been remitted from the first virtual account to the second virtual account.

Thus, FIG. 9 shows still another example processing flow of operations for implementing at least portions of refusing a remittance utilizing a first electronic wallet 122.

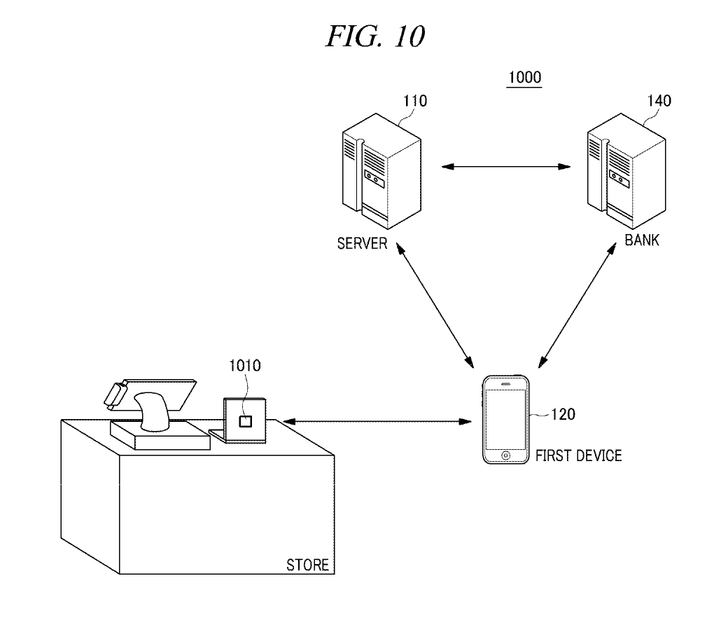

FIG. 10 shows yet another example system configuration 1000 in which one or more embodiments of electronic wallet based remittance may be implemented. As depicted in FIG. 10, system configuration 1000 includes, at least, a server 110, a first device 120, one or more bank servers 140 (operated by a bank or other financial institution; referred hereafter as “bank server 140” though not limited in quantity) and an electronic tag 1010, which may be attached to a surface of an object, such as a checkout counter, a point of sale (POS) terminal, etc., located at a place of commerce. Alternatively, electronic tag 1010 may be inserted in the example objects as an electronic chip. At least one of server 110, first device 120, bank server 140 and electronic tag 1010 may be connected to each other via a wireless network or a wired network. Here, since the function and operation of server 110, first device 120 and bank server 140 are similar to those of the server 110, first device 120 and bank server 140 discussed above in FIG. 1, redundant description thereof will be omitted herein.

As referenced herein, an “electronic tag,” also known as a “smart tag” or “NFC tag” or “RFID tag,” may be an electronic identification device that includes a chip and antenna.

Server 110 may be further configured to receive a transaction request including a payment amount and a store identifier from first device 120; and then, to transmit, to bank server 140, a request to transfer the payment amount from a first virtual account to a store account for a place of commerce corresponding to the store identifier in order to complete a transaction. As referenced herein, non-limiting examples of the store identifier may include at least one of a store name, a store address, a telephone number of the store, a point of sale (POS) terminal number or a business license number. As further referenced herein, the request to transfer the payment amount may include a first account identifier of the first virtual account and an account identifier of the store account. The account identifier of the store account may be retrieved from a memory of server 110 by using the received store identifier. Then, server 110 may receive from bank server 140 a notification indicating completion of payment, and transmit to first device 120 the notification indicating completion of payment. As referenced herein, the notification indicating completion of payment may be transmitted to first device 120 with an electronic receipt by server 110. As further referenced herein, the electronic receipt may include the current balance corresponding to first electronic wallet 122, the payment amount, store information, such as the store name, the store address, the telephone number of the store, the account identifier of the store account corresponding to the store, etc.

In some embodiments, first device 120 may include a reader that is enabled to read information from an electronic tag. By way of example, but not limitation, the reader integrated in or coupled to first device 120 may include one or more of a radio frequency identification reader, a near field communication reader, a barcode reader, a quick response code reader, etc.

First device 120 may be further configured to read electronic tag 140 located within a predetermined communication range of first device 120 by using the aforementioned reader to acquire the store identifier stored in the electronic tag. First device 120 may transmit to server 110 the acquired store identifier to request aforementioned store information corresponding to the acquired store identifier. In some embodiments, the store information may be pre-stored in the electronic tag. That is, first device 120 may acquire the store information by reading the electronic tag by using the reader coupled to first device 120.

First device 120 may be further configured to receive input data including the payment amount into a user interface (UI) field by the first user of first device 120. Alternatively, first device 120 may receive the payment amount, as a cashier beams the payment amount to first device 120. First device 120 may be further configured to transmit the transaction request, including the payment amount and the acquired store identifier, to server 110. As referenced herein, the transmitted store identifier may be used by server 110 to retrieve the account identifier of the store account for payment of the payment amount. In some embodiments, first device 120 may acquire the account identifier of the store account that is pre-stored in electronic tag 1010 by reading electronic tag 1010, and then, transmit the acquired account identifier of the store account to server 110. First device 120 may be configured to receive, from server 110, the notification indicating completion of payment with the electronic receipt. Alternatively, first device 120 may receive the notification indicating completion of payment with the electronic receipt from bank server 140.

First device 120 may display at least one of the notification indicating completion of payment, the store information or the electronic receipt on display panel 125 installed on or coupled to first device 120, to inform the first user that a payment has been successfully completed.

Bank server 140 may be further configured to receive, from server 110, the request to transfer the payment amount from the first virtual account to the store account with the first account identifier of the first virtual account and the account identifier of the store account. Bank server 140 may be further configured to transfer the payment amount from the first virtual account to the store account by using the first account identifier of the first virtual account and the account identifier of the store account. Bank server 140 may further transmit the notification indicating completion of payment to server 110. In some embodiments, bank server 140 may be configured to transmit the notification indicating completion of payment to first device 120.

Electronic tag 1010, by way of example but not limitation, may include at least one of a barcode, a quick response code, a smart tag, a radio frequency identification (REID) tag, a near field communication (NEC) tag, etc. Further, as referenced herein, an electronic tag 1010 may be an electronic identification device that includes a chip and antenna.

Thus, FIG. 10 shows yet another example system configuration 1000 in which one or more embodiments of electronic wallet based remittance may be implemented.

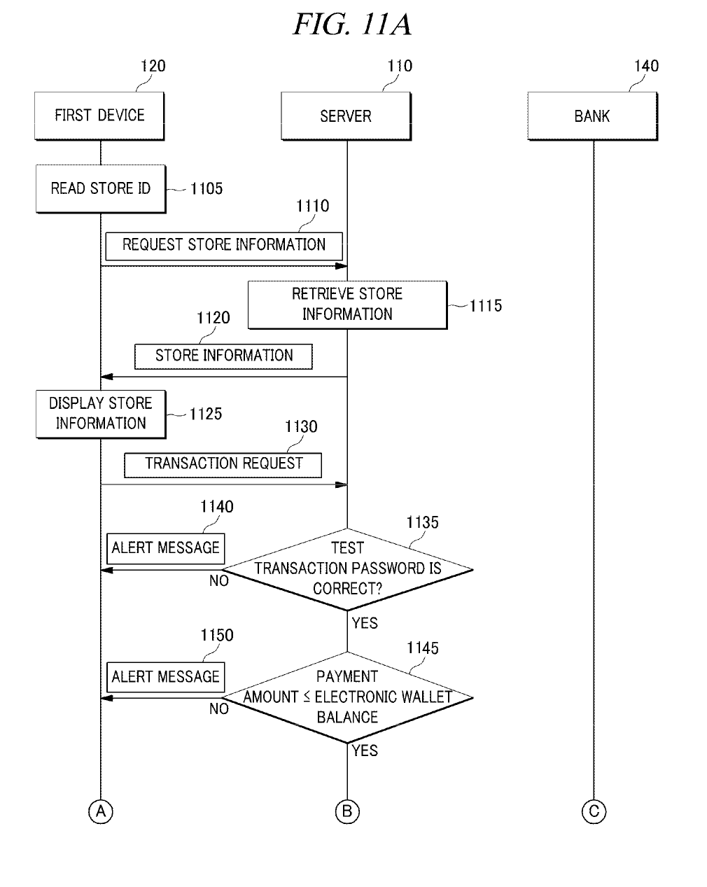

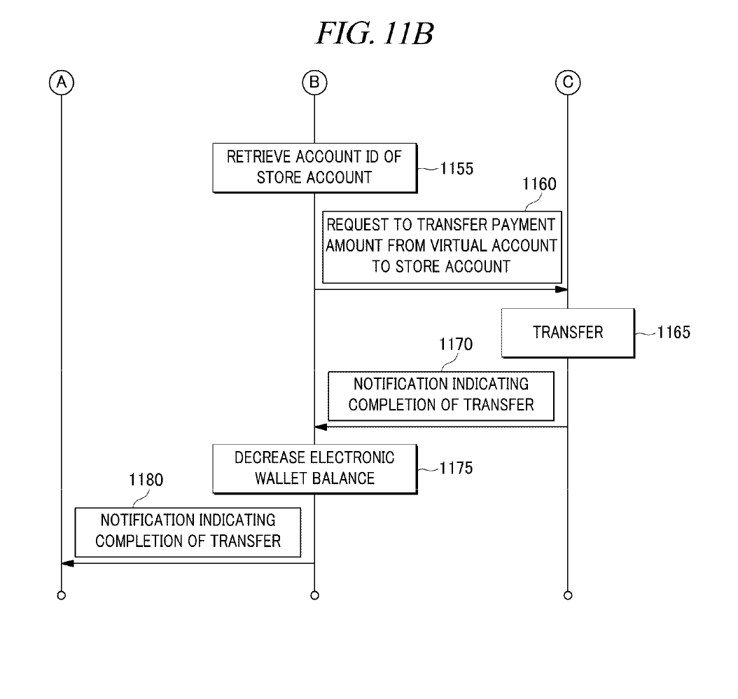

FIG. 11 shows an example processing flow of operations for implementing at least portions of making a remittance utilizing a first electronic wallet 122. The process in FIG. 11 may be implemented in system configuration 1000 including server 110, first device 120 and bank server 140, as described with reference to FIG. 1. An example process may include one or more operations, actions, or functions as illustrated by one or more blocks 1105, 1110, 1115, 1120, 1125, 1130, 1135, 1140, 1145, 1150, 1155, 1160, 1165, 1170, 1175 and/or 1180. Although illustrated as discrete blocks, various blocks may be divided into additional blocks, combined into fewer blocks, or eliminated, depending on the desired implementation. Processing may begin at block 1105.

Block 1105 (Read Store identifier) may refer to first device 120 reading a store identifier, which may be received from an electronic tag 1010 located within predetermined communication range of first device 120. Non-limiting examples of electronic tag 1010 may include a barcode, a quick response code, a smart tag, a radio frequency identification (RFID) tag, a near field communication (NEC) tag, etc. For example, first device 120 may capture an image of electronic tag 1010, which may be attached to a surface of an object, such as the barcode or the quick response code, by using an image sensor integrated in or coupled to first device 120. Thus, first device 120 may acquire the store identifier pre-stored in electronic tag 1010. As referenced herein, non-limiting examples of the object may include a checkout counter, a point of sale (POS) terminal, etc. In some embodiments, first device 120 and electronic tag 1010 make physical contact or be in close proximity of each other. First device 120 may recognize electronic tag 1010, which may be inserted in the objects as an electronic chip, such as a near field communication tag or a radio frequency identification tag, and acquire the store identifier. In some other embodiments, first device 120 may acquire the store identifier by receiving a user input including the store identifier. Processing may proceed from block 1105 to block 1110.

Block 1110 (Transmit Request Store Information) may refer to first device 120 transmitting a request for store information, to server 110, by inserting the read store identifier into the request. Processing may proceed from block 1110 to block 1115.

Block 1115 (Retrieve Store Information) may refer to server 110 retrieving the store information from a memory by using the store identifier. As referenced herein, the store information, such as a store name, a store address, a telephone number of the store or an account identifier of a store account corresponding to the store, may be pre-stored in the memory of server 110. That is, server 110 may receive the store information, and then register the received store information with respect to the store identifier in the memory. Processing may proceed from block 1115 to block 1120.

Block 1120 (Transmit Store Information) may refer to server 110 transmitting the retrieved store information to first device 120. Processing may proceed from block 1120 to block 1125.

Block 1125 (Display Store Information) may refer to first device 120 displaying the received store information on display panel 125 installed on or coupled to first device 120. Before making a payment, a first user of first device 120 may determine whether the displayed store information is correct or not, and, if the displayed store is correct, the first user may determine to complete the payment. Processing may proceed from block 1125 to block 1130.

Block 1130 (Transmit Transaction Request) may refer to first device 120 transmitting, to server 110, a transaction request including a first device identifier, a payment amount to be paid and a test transaction password that is newly input through a user input. As referenced herein, the payment amount may be input by the first user through a user input. Alternatively, the payment amount may be transmitted by beaming the payment amount from a casher to first device 120. In some embodiments, the payment amount may be received from an electronic tag attached to a surface of an object, such as, a merchant that is to be bought, a price tag, a menu, etc. Processing may proceed from block 1130 to block 1135.

Block 1135 (Determine whether Test Transaction Password is Correct) may refer to server 110 determining whether the received test transaction password is correct or not by comparing the received test transaction password to a stored transaction password with respect to the received first device identifier. Processing may proceed from block 1135 to block 1140 or block 1145 based on a result of the determination. That is, if the test transaction password is not correct, processing may proceed from block 1135 to block 1140; while if the test transaction password is correct, processing may proceed from block 1135 to block 1145.

Block 1140 (Transmit Alert Message) may refer to server 110 transmitting a notification that the test transaction password is not correct, to first device 120, as an alert. In this case, first device 120 may display the received notification, and provide the first user a chance to input a new test transaction password.

Block 1145 (Determine whether Payment Amount is Same or Less than Current Balance corresponding to First Electronic Wallet 122) may refer to server 110 determining whether a payment amount is equal to or less than a current balance corresponding to first electronic wallet 122 with respect to the received first device identifier. As referenced herein, the current balance corresponding to first electronic wallet 122 may be independently managed by server 110 and be retrieved from the memory of server 110. Alternatively, server 110 may receive, from bank server 140, a current balance of a first virtual account independently managed by bank server 140 as the current balance corresponding to the electronic wallet. If the payment amount exceeds the current balance corresponding to first electronic wallet 122, processing may proceed from block 1145 to block 1150; if the payment amount is same or less than the current balance corresponding to first electronic wallet 122, processing may proceed from block 1145 to block 1155.

Block 1150 (Transmit Alert Message) may refer to server 110 transmitting a notification that the payment amount exceeds the current balance corresponding to first electronic wallet 122, to first device 120, as an alert. In this case, first device 120 may display the received notification, and then display a user interface field to input an additional amount of funds or purchase credits into first electronic wallet 122.

Block 1155 (Retrieve Account Identifier of Store Account) may refer to server 110 retrieving the account identifier of the store account by using the received store identifier from the memory of server 110. In some embodiments, server 110 may determine whether the first virtual account and/or the store account is available or not. Processing may proceed from block 1155 to block 1160.

Block 1160 (Transmit Request to Transfer Payment Amount from First Virtual Account to Store Account) may refer to server 110 transmitting, to bank server 140, a request to transfer the payment amount from the first virtual account to the store account. As referenced herein, the request to transfer may include an first account identifier of the first virtual account, the retrieved account identifier of the store account and the received payment amount. For example, first device 120 may retrieve a first account identifier of the first virtual account corresponding to first electronic wallet 122 by using the received first device identifier. Processing may proceed from block 1160 to block 1165.

Block 1165 (Transfer Payment Amount) may refer to bank server 140 transferring the payment amount from the first virtual account to the store account. Processing may proceed from block 1165 to block 1170.

Block 1170 (Transmit Notification indicating Completion of Transfer) may refer to bank server 140 transmitting a notification indicating completion of transfer of the payment amount to server 110. Processing may proceed from block 1170 to block 1175.

Block 1175 (Decrease Current Balance corresponding to First Electronic Wallet 122) may refer to server 110 decreasing the current balance corresponding to first electronic wallet 122 by the payment amount. In some embodiments, server 110 may receive the current balance of the first virtual account from bank server 140, and then adjust the current balance corresponding to first electronic wallet 122 to equal the received current balance of the first virtual account instead of decreasing the current balance corresponding to first electronic wallet 122 by the payment amount. Therefore, the current balance corresponding to first electronic wallet 122 may be synchronized with the current balance of the first virtual account. Processing may proceed from block 1175 to block 1180.

Block 1180 (Transmit Notification indicating Completion of Transfer) may refer to server 110 transmitting the received notification indicating the completion of the transfer with the current balance corresponding to first electronic wallet 122 independently managed by server 110. Further, first device 120 may display the received notification indicating the completion of the transfer with the current balance corresponding to first electronic wallet 122 on a display panel. Thus, the first user of first device 120 may be informed that the requested transaction has been completed and that the requested payment amount has been transferred from the first virtual account to the store account safely.

Thus, FIG. 11 shows an example processing flow of operations for implementing at least portions of making a remittance utilizing a first electronic wallet 122.

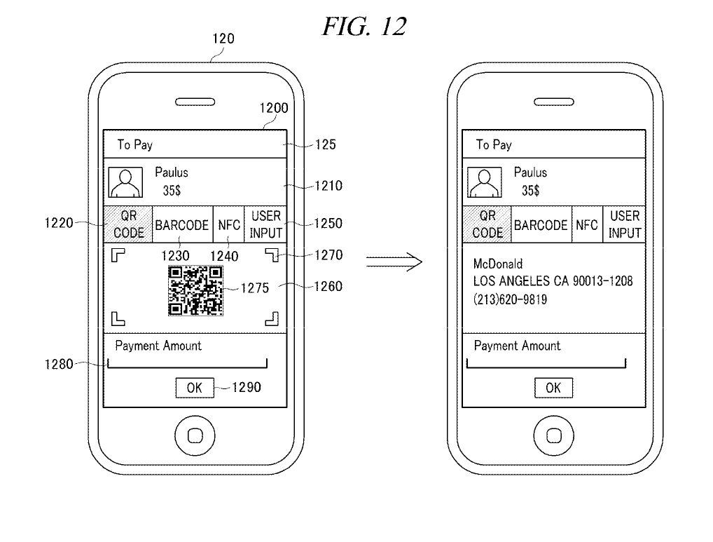

FIG. 12 shows yet another illustrative example of a first device 120 in which one or more embodiments of electronic wallet based payment may be implemented. First device 120, which is described above with regard to FIG. 1, may be configured to display a user interface 500 for making a payment on a display panel 125 installed on first device 120. First device 120 may be configured to display user interface 1200 when receiving a user input with respect to a request to make a payment.

By way of example, as depicted in FIG. 12, user interface 1200 may include a first field 1210, icons for a quick response code 1220, a barcode 1230, a near field communication 1240 and a user input 1250, a second field 1260, an input field for a payment amount 1280 and an “OK” icon 1290.

First field 1210 may include at least one of an image, a user name, or a current balance corresponding to electronic wallet 122. First field 1210 may further include at least one of a login identifier, a telephone number of first device 120, or a first account identifier of a first virtual account.

Based on which of icons 1220 to 1250 is clicked, selected, or otherwise activated, an entity to be shown on second field 1280 may be determined.

By way of examples, when an icon for the quick response code 1220 is clicked, selected, or otherwise activated, indicators 1270 that set a boundary to identify a quick response code 1275 may be shown on second field 1260. As depicted in FIG. 12, a camera integrated in or coupled to first device 120 may capture an image of quick response code 1275 located near first device 120, and, then the captured image may be shown in second field 1260 to facilitate a capturing motion of a first user of first device 120.

Similarly, when an icon for the barcode 1230 is clicked, selected, or otherwise activated, second field 1260 may show indicators 1270 that set a boundary to identify a barcode. In this case, the camera integrated in or coupled to first device 120 may capture an image of the barcode located near first device 120, and, then the captured image may be shown in second field 1260 to facilitate a capturing motion of the first user of first device 120.

When an icon for the near field communication 1240 is clicked, selected, or otherwise activated, second field 1260 may show a notice indicating that first device 120 may be close to a near field communication tag.

Further, when an icon for the user input 1250 is clicked, selected, or otherwise activated, second field 1260 may show an field for the first user to input a store identifier, such as a store name, a store address, a telephone number of a store, a business license number, etc. Thus, first device 120 may acquire a store identifier and transmit the acquired store identifier to server 110. Then, first device 120 may receive store information corresponding to the store identifier from server 110, and display the received store information on second field 1260.

As depicted in FIG. 12, the first user may click, select, or otherwise activate an icon for the quick response code 1220 and locate a quick response code 1275 inside of indicators 1270. Then, an entity shown on second field 1260 may be changed into store information including “McDonalds” as a store name, “LOS ANGELES CA 90013-1208” as a store address and “(213) 620-9819” as a telephone number of the store corresponding to a store identifier as further depicted in FIG. 12.

Input field for the payment amount 1280 may be configured to receive an input of a payment amount corresponding to merchandise price or service price to be paid. When the first user inputs the payment amount on input field 1280 and clicks, selects, or otherwise activates “OK” icon 1290, first device 120 may transmit a transaction request to transfer the payment amount from a virtual account to a store account.

Thus, FIG. 12 shows yet another illustrative example of a first device 120 in which one or more embodiments of electronic wallet based payment may be implemented.

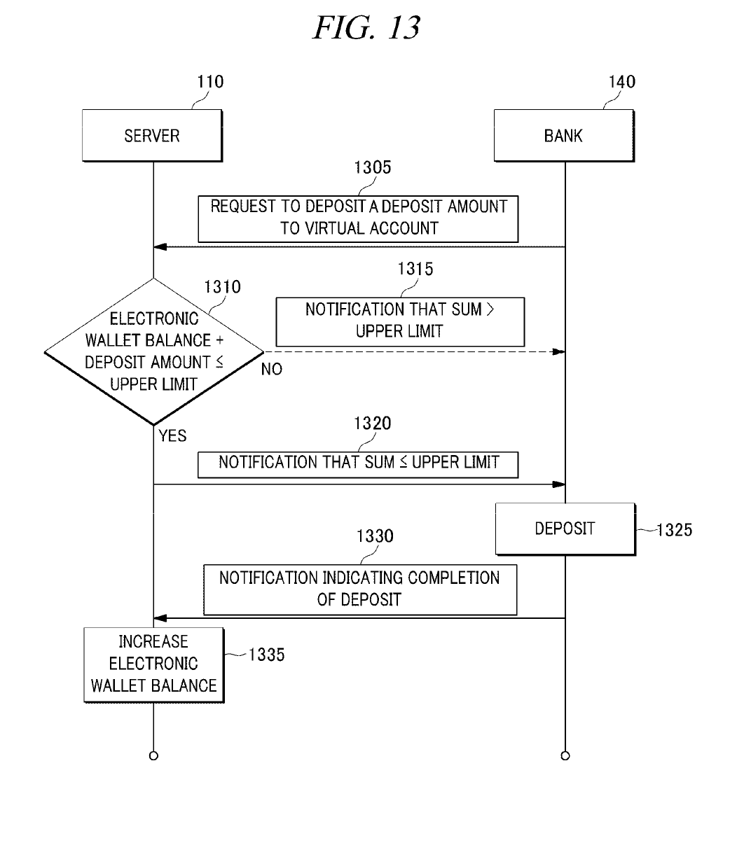

FIG. 13 shows an example processing flow of operations for implementing at least portions of increasing a current balance corresponding to first electronic wallet 122. The process in FIG. 13 may be implemented in system configuration 100 including server 110 and bank server 140, as described with reference to FIG. 1. An example process may include one or more operations, actions, or functions as illustrated by one or more blocks 1305, 1310, 1315, 1320, 1325, 1330 and/or 1335. Although illustrated as discrete blocks, various blocks may be divided into additional blocks, combined into fewer blocks, or eliminated, depending on the desired implementation. Processing may begin at block 1305.

Block 1305 (Transmit Request to Deposit a Deposit Amount to First Virtual Account) may refer to bank server 140 transmitting a request to deposit a deposit amount to a first virtual account corresponding to first electronic wallet 122 hosted on first device 120. As referenced herein, the request to deposit may include the payment amount and a first account identifier of the first virtual account. Thus, when bank server 140 receives the deposit amount with the first account identifier of the first virtual account from an external source, bank server 140 may transmit, to server 110, the request to deposit to ask server 110 whether bank server 140 should deposit the deposit amount into the first virtual account.

In some embodiments, the deposit amount may be matched to a predefined usage corresponding to the external source, such as a remittance, a payment, etc. By way of example, when the deposit amount is input into the first virtual account from someone's virtual account, the deposit amount may be utilized for only making a payment. By way of other example, when the deposit amount is input into the first virtual account from a first user's credit card account, the deposit amount may be utilized for only making a remittance. Processing may proceed from block 1305 to block 1310.

Block 1310 (Determine whether Sum of Current Balance corresponding to First Electronic Wallet and Deposit Amount Exceeds Upper Limit allotted to First Electronic Wallet 122) may refer to server 110 determining whether a sum of a current balance corresponding to first electronic wallet 122, independently managed by server 110, and the deposit amount exceeds an upper limit allotted to first electronic wallet 122. As referenced herein, the upper limit allotted to first electronic wallet 122 may be set by the first user of first device 120 in advance. Further, the first user may decide the upper limit through a user interface for setting the upper limit displayed on first device 120. If the sum exceeds the upper limit, processing may proceed from block 1310 to block 1315, while if the sum does not exceed the upper limit, processing may proceed from block 1310 to block 1320.

Block 1315 (Transmit Notification that Sum Exceeds Upper Limit) may refer to server 110 transmitting a notification that the sum exceeds the upper limit to bank server 140 as a message indicating failure of the deposit. Then, bank server 140 would not deposit the deposit amount into the first virtual account but rather return the deposit amount to the external source with the notification that the sum exceeds the upper limit. Processing may proceed from block 1315 to block 1320.

Block 1320 (Transmit Notification that Sum does not Exceed Upper Limit) may refer to server 110 transmitting a notification, to bank server 140, that the sum does not exceed the upper limit. In some embodiments, before transmitting the notification to bank server 140, server 110 may transmit, to first device 120, an acknowledgement that bank server 140 has received a deposit amount from an external source. Then, if server 110 receives a confirmation with respect to the acknowledge from first device 120, server 110 may transmit the notification to bank server 140. Processing may proceed from block 1320 to block 1325.

Block 1325 (Deposit The Deposit Amount) may refer to bank server 140 depositing the deposit amount to the first virtual account. Processing may proceed from block 1325 to block 1330.

Block 1330 (Transmit Notification indicating Completion of Deposit) may refer to bank server 140 transmitting a notification indicating completion of the deposit to server 110. Bank server 140 may further transmit the notification indicating the completion to the outside. Processing may proceed from block 1330 to block 1335.

Block 1335 (Increase Current Balance corresponding to First Electronic Wallet 122) may refer to server 110 increasing the current balance corresponding to first electronic wallet 122 by the deposit amount. Alternatively, server 110 may receive the current balance of the first virtual account, and then adjust the current balance corresponding to first electronic wallet 122 to equal the current balance of the first virtual account. Therefore, the current balance corresponding to first electronic wallet 122 may be synchronized with the current balance of the first virtual account.

Thus, FIG. 13 shows an example processing flow of operations for implementing at least portions of increasing a current balance corresponding to a first electronic wallet 122.

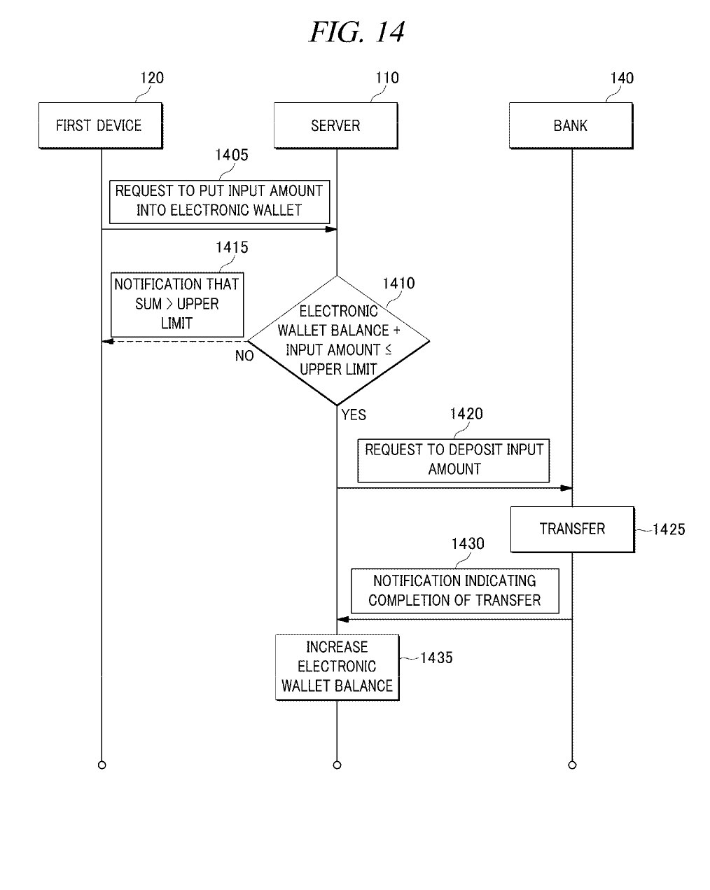

FIG. 14 shows yet another example processing flow of operations for implementing at least portions of increasing a current balance corresponding to a first electronic wallet 122. The process in FIG. 14 may be implemented in system configuration 100 including server 110, first device 120 and bank server 140, as described with reference to FIG. 1. An example process may include one or more operations, actions, or functions as illustrated by one or more blocks 1405, 1410, 1415, 1420, 1425, 1430 and/or 1435. Although illustrated as discrete blocks, various blocks may be divided into additional blocks, combined into fewer blocks, or eliminated, depending on the desired implementation. Processing may begin at block 1405.

Block 1405 (Transmit Request to Put Input Amount into First Electronic Wallet 122) may refer to first device 120 transmitting a request to put an input amount into first electronic wallet 122 hosted on first device 120. As referenced herein, a first user may identify an original source of the input amount, such as a credit card account, a debit card account, a virtual account, a reward point account or a bank account, and the request to put the input amount may include information regarding the decided original source. By way of example, when the credit card account is identified as the original source, the request to put may include a credit card number, an expiration date, a credit card password, etc. The information regarding the identified original source may be received from a first user through a user input. Processing may proceed from block 1405 to block 1410.

Block 1410 (Determine whether Sum of Current Balance corresponding to First Electronic Wallet and Input Amount Exceeds Upper Limit) may refer to server 110 determining whether a sum of a current balance corresponding to first electronic wallet 122 independently managed by server 110 and the input amount exceeds an upper limit allotted to first electronic wallet 122. As referenced herein, the upper limit allotted to first electronic wallet 122 may be set by the first user in advance. Further, the first user may determine or identify the upper limit through a user interface to set the upper limit displayed on first device 120. If the sum exceeds the upper limit, processing may proceed from block 1410 to block 1415, while if the sum does not exceed the upper limit, processing may proceed from block 1410 to block 1420.

Block 1415 (Transmit Notification that Sum Exceeds Upper Limit) may refer to server 110 transmitting a notification or alert that the sum exceeds the upper limit to first device 120. Then, first device 120 may display the notification that the sum exceeds the upper limit. Processing may proceed from block 1415 to block 1420.

Block 1420 (Transmit Request to Deposit Input Amount) may refer to server 110 transmitting a request to deposit the input amount to bank server 140. As referenced herein, the request to deposit may include the information regarding the identified original source. Processing may proceed from block 1420 to block 1425.

Block 1425 (Transfer Input Amount) may refer to bank server 140 transferring the input amount to the first virtual account. For example, bank server 140 may transfer the input amount from the original source to the first virtual account by using the received information regarding the original source. Processing may proceed from block 1425 to block 1430.

Block 1430 (Transmit Notification indicating Completion of Transfer) may refer to bank server 140 transmitting a notification indicating completion of transfer of the input amount to server 110. Processing may proceed from block 1430 to block 1435.

Block 1435 (Increase Current Balance corresponding to First Electronic Wallet 122) may refer to server 110 increasing the current balance corresponding to first electronic wallet 122 by the input amount. Alternatively, server 110 may receive the current balance of the first virtual account, and then, adjust the current balance corresponding to first electronic wallet 122 to equal the current balance of the first virtual account. Therefore, the current balance corresponding to first electronic wallet 122 may be synchronized with the current balance of the first virtual account.

Thus, FIG. 14 shows yet another example processing flow of operations for implementing at least portions of increasing a current balance corresponding to a first electronic wallet 122.

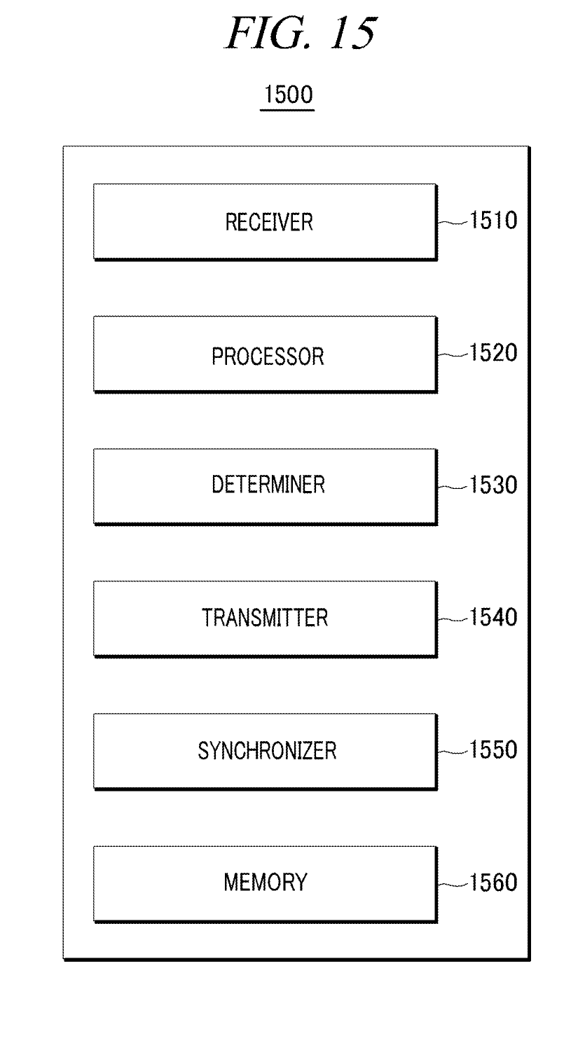

FIG. 15 shows an example configuration of a server 110 by which at least portions of electronic wallet based remittance may be implemented. As depicted in FIG. 15, server 110, which is described above with regard to FIGS. 1-14, may include a receiver 1510, a processor 1520, a determiner 1530, a transmitter 1540, a synchronizer 1550 and a memory 1560. Although illustrated as discrete components, various components may be divided into additional components, combined into fewer components, or eliminated altogether while being contemplated within the scope of the disclosed subject matter. Each function and/or operation of the components may be implemented, individually and/or collectively, by a wide range of hardware, software, firmware, or any combination thereof. In that regard, one or more of receiver 1510, processor 1520, determiner 1530, transmitter 1540, synchronizer 1550 and memory 1560 may be included in an instance of an application hosted by server 110.

Receiver 1510 may be configured to receive, from a first device 120, a request to issue first electronic wallet 122 to be hosted on first device 120. As referenced herein, the request to issue first electronic wallet 122 may include at least one of an end device identifier, a user identifier, a remittance password or a transaction password.

Receiver 1510 may be further configured to receive a remittance request from first device 120. Here, the remittance request may include a remittance amount to be remitted, a second device identifier of second device 130, and a test remittance password that is to be compared with the remittance password stored in memory 1560 to making a remittance.

Receiver 1510 may be further configured to receive a notification that a first virtual account has been generated with a first account identifier of the generated first virtual account from bank sever 140. Receiver 1510 may be further configured to receive, from bank server 140, a notification indicating completion of deposit or remittance of the remittance amount.

Processor 1520 may be configured to issue first electronic wallet 122 in response to the received request to issue first electronic wallet 122. Processor 1520 may be further configured to match the received first account identifier of the first virtual account to issued first electronic wallet 122.

Processor 1520 may be configured to compare the test remittance password included in the received remittance request with the remittance password in response to the received remittance request.

Determiner 1530 may be configured to determine whether a second electronic wallet has been issued to second device 130 in response to the received remittance request. In some embodiments, determiner 1530 may be further configured to determine whether first electronic wallet 122 is available in response to the received remittance request.

Transmitter 1540 may be configured to transmit, to a bank server 140, a request to generate the first virtual account corresponding to first electronic wallet 122 if first electronic wallet 122 is issued.

Transmitter 1540 may be further configured to transmit, to bank server 140, a request to deposit the remittance amount from the first virtual account to a virtual account of server 110 if the second electronic wallet has not been issued. Otherwise, transmitter 1540 may be further configured to transmit, to bank server 140, a request to deposit the remittance amount from the first virtual account to a second virtual account corresponding to second device 130 if the second electronic wallet has not issued.

Synchronizer 1550 may be configured to synchronize between the current balance corresponding to first electronic wallet 122 and the current balance of the first virtual account. For example, synchronizer 1550 may decrease a current balance corresponding to first electronic wallet 122 independently managed by server 110 by the remittance amount based on the received notification indicating completion of deposit or remittance, to equal a current balance of the first virtual account independently managed by bank server 140.

Memory 1560 may be configured to store at least one of a password, such as a remittance password, a first virtual account password, or a first device identifier with respect to issued first electronic wallet 122. Further, memory 1560 may be configured to store the received first account identifier of the generated first virtual account with respect to issued first electronic wallet 122.

Thus, FIG. 15 shows an example configuration of a server 110 by which at least portions of electronic wallet based remittance may be implemented.

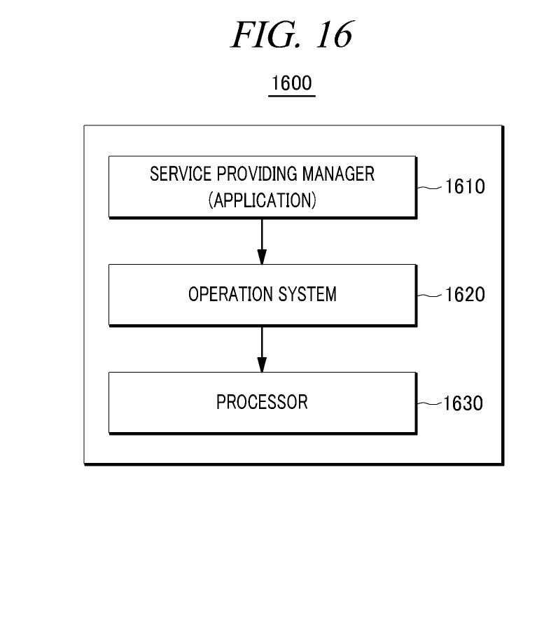

FIG. 16 shows still another example configuration of a server 110 by which at least portions of electronic wallet based remittance may be implemented. As depicted in FIG. 16, server 110, which is described above with regard to FIGS. 1-15, may include a service providing manager 1610, an operating system 1620 and a processor 1630.

Service providing manager 1610 may be an application configured to operate on operating system 1620 such that the electronic wallet based remittance schemes as described herein may be implemented.

Operating system 1620 may allow service providing manager 1610 to manipulate processor 1630 to implement the electronic wallet based remittance schemes as described herein.

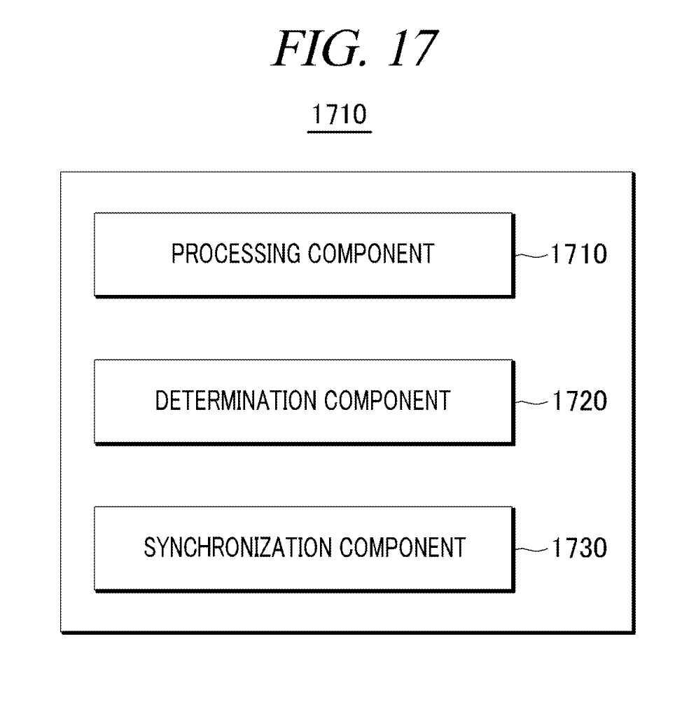

FIG. 17 shows an example configuration of a service providing manager 1610 by which at least portions of electronic wallet based remittance may be implemented. As depicted, service providing manager 1610 may include a processing component 1710, a determination component 1720 and a Synchronization component 1730.

Processing component 1710 may be configured to issue first electronic wallet 122 to be hosted on first device 120 in response to a request to issue first electronic wallet 122. Processing component 1710 may be further configured to match a first account identifier of a first virtual account to issued first electronic wallet 122. As referenced herein, the first virtual account may be generated by bank server 140, and the first account identifier of the generated first virtual account may be transmitted from bank server 140 to a server 110.

Determination component 1720 may be configured to determine whether a second electronic wallet has been issued to second device 130 to decide a form of a request to be transmitted to second device 130 or bank server 140. As referenced herein, the request may include a request to accept a remittance amount to be transmitted to second device 130 in case that the second electronic wallet has been issued. Further, the request may include a request to deposit the remittance amount to be transmitted to bank server 140 in case that the second electronic wallet has not been issued.

Synchronization component 1730 may be configured to adjust a current balance corresponding to first electronic wallet 122 independently managed by server 110 to equal a current balance of the first virtual account independently managed by bank server 130. Therefore, the current balance corresponding to first electronic wallet 122 may be synchronized with the current balance of the first virtual account.

Thus, FIG. 16 shows still another example configuration of a server 110 by which at least portions of electronic wallet based remittance may be implemented, and FIG. 17 shows an example configuration of a service providing manager 1610 by which at least portions of electronic wallet based remittance may be implemented.

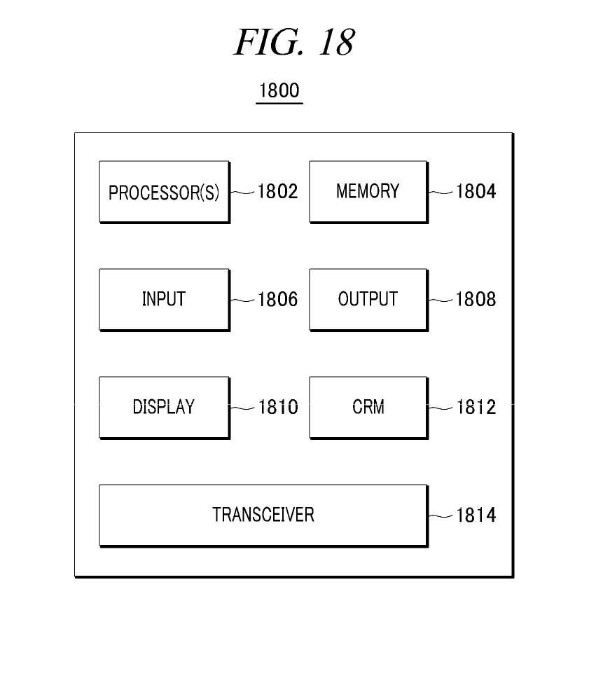

FIG. 18 shows an illustrative computing embodiment, in which any of the processes and sub-processes of electronic wallet based remittance may be implemented as computer-readable instructions stored on a computer-readable medium. The computer-readable instructions may, for example, be executed by a processor of a device, as referenced herein, having a network element and/or any other device corresponding thereto, particularly as applicable to the applications and/or programs described above corresponding to the configuration 100 for transactional permissions.

In a very basic configuration, a computing device 1800 may typically include, at least, one or more processors 1802, a system memory 1804, one or more input components 1806, one or more output components 1808, a display component 1810, a computer-readable medium 1812, and a transceiver 1814.

Processor 1802 may refer to, e.g., a microprocessor, a microcontroller, a digital signal processor, or any combination thereof.

Memory 1804 may refer to, e.g., a volatile memory, non-volatile memory, or any combination thereof. Memory 1804 may store, therein, an operating system, an application, and/or program data. That is, memory 1804 may store executable instructions to implement any of the functions or operations described above and, therefore, memory 1804 may be regarded as a computer-readable medium.

Input component 1806 may refer to a built-in or communicatively coupled keyboard, touch screen, or telecommunication device. Alternatively, input component 1806 may include a microphone that is configured, in cooperation with a voice-recognition program that may be stored in memory 1804, to receive voice commands from a user of computing device 1800. Further, input component 1806, if not built-in to computing device 1800, may be communicatively coupled thereto via short-range communication protocols including, but not limitation, radio frequency or Bluetooth.

Output component 1808 may refer to a component or module, built-in or removable from computing device 1800, that is configured to output commands and data to an external device.

Display component 1810 may refer to, e.g., a solid state display that may have touch input capabilities. That is, display component 1810 may include capabilities that may be shared with or replace those of input component 1806.

Computer-readable medium 1812 may refer to a separable machine readable medium that is configured to store one or more programs that embody any of the functions or operations described above. That is, computer-readable medium 1812, which may be received into or otherwise connected to a drive component of computing device 1800, may store executable instructions to implement any of the functions or operations described above. These instructions may be complimentary or otherwise independent of those stored by memory 1804.

Transceiver 1814 may refer to a network communication link for computing device 1800, configured as a wired network or direct-wired connection. Alternatively, transceiver 1814 may be configured as a wireless connection, e.g., radio frequency (RF), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A method performed by a server, comprising:
issuing a first electronic wallet to be hosted on a first device;
receiving, from the first device, a remittance request including a remittance amount and an identifier of a second device;
determining whether a second electronic wallet has been issued to be hosted on the second device;
transmitting, to a bank, a request to deposit the remittance amount from a first virtual account corresponding to the first electronic wallet to a virtual account corresponding to the server, if an issued result of the determining is negative; and
transmitting a request to accept the deposited remittance amount to the second device.

2. The method of claim 1, further comprising:
receiving, from the second device, a request to remit the deposited remittance amount and an account identifier of a bank account corresponding to the second device; and
transmitting, to the bank, a request to remit the deposited remittance amount to the bank account.

3. The method of claim 2, further comprising:
receiving, from the bank, a notification indicating a completion of remittance of the deposited remittance amount;
transmitting the notification to the first device.

4. The method of claim 1, further comprising:
receiving, from the second device, a request for the second electronic wallet to be issued;
issuing the second electronic wallet to be hosted on the second device; and
transmitting, to the bank, a request for the deposited remittance amount to be remitted to a second virtual account corresponding to the issued second electronic wallet.

5. The method of claim 1, further comprising:
receiving, from the second device, a message that refuses the request to accept; and
transmitting, to the bank, a request to return the deposited remittance amount to the first virtual account corresponding to the first electronic wallet.

6. The method of claim 1, further comprising:
transmitting, to the bank, a request to return the deposited remittance amount to the first virtual account corresponding to the first electronic wallet if no response to the request to accept is received within a predetermined time.

7. The method of claim 1, further comprising:
receiving, from the bank, a notification indicating deposit of the remittance amount; and
decreasing a current balance corresponding to the first electronic wallet by the deposited remittance amount.

8. The method of claim 5, further comprising:
receiving, from the bank, a notification indicating that the deposited remittance amount has been returned; and
increasing a current balance corresponding to the first electronic wallet by the returned remittance amount.

9. The method of claim 1, further comprising:
transmitting, to the second device, a request to accept the remittance amount if the second electronic wallet has been issued.

10. The method of claim 9, further comprising:
receiving, from the second device, a notification indicating an approval of the request to accept the remittance amount; and
transmitting, to the bank, a request to remit the remittance amount from the first virtual account corresponding to the first electronic wallet to a second virtual account corresponding to the second electronic wallet.

11. The method of claim 9, further comprising:
receiving, from the second device, a notification indicating a refusal of the request to accept the remittance amount; and
transmitting, to the first device, the notification indicating a refusal.

12. The method of claim 1, further comprising:
determining whether the remittance amount to be deposited is the same or less than a current balance corresponding to the first electronic wallet; and
transmitting, to the first device, an alert message if the remittance amount is greater than the current balance corresponding to the first electronic wallet.

13. The method of claim 1, further comprising:
receiving a request to put an input amount into the first electronic wallet;
determining whether a sum of a current balance corresponding to the first electronic wallet and the input amount exceeds an upper limit allotted to the first electronic wallet; and
increasing the current balance corresponding to the first electronic wallet by the input amount if the sum falls within the upper limit.

14. The method of claim 13, further comprising:
matching the input amount with one of at least one predefined usages based on a source for putting the input amount.

15. The method of claim 13, further comprising:
receiving an input regarding at least one usage with respect to the input amount; and
matching the input amount with the at least one usage.

16. The method of claim 1, further comprising:
transmitting, to the bank, a request to generate a first virtual account corresponding to the issued first electronic wallet.

17. The method of claim 16, wherein the first electronic wallet corresponds to an application executable on the first device, and a current balance corresponding to the first electronic wallet is synchronized with a current balance of the generated first virtual account.

18. The method of claim 1, wherein the issuing the first electronic wallet comprises:
receiving, from the first device, an identifier and a remittance password; and
registering the identifier and the remittance password associated with the first electronic wallet in a memory.

19. A server, comprising:
a processor configured to issue a first electronic wallet to be hosted on a first device;
a receiver configured to receive, from the first device, a remittance request including a remittance amount and an identifier of a second device;
a determiner configured to determine whether a second electronic wallet has been issued to be hosted on the second device;
a transmitter configured to transmit, to a bank, a request to deposit the remittance amount from a first virtual account corresponding to the first electronic wallet to a virtual account corresponding to the server, if the second electronic wallet has not been issued; and
transmit, to the second device, a request to accept the deposited remittance amount.

20. The server of claim 19, wherein the receiver is further configured to receive, from the second device, a request to remit the deposited remittance amount and an account identifier of a bank account corresponding to the second device, and
wherein the transmitter is further configured to transmit, to the bank, a request to remit the deposited remittance amount to the bank account.

21. The server of claim 19, wherein the receiver is further configured to receive, from the second device, a request to issue the second electronic wallet, and
wherein the processor is further configured to issue the second electronic wallet to be hosted on the second device, and
wherein the transmitter is further configured to transmit, to the bank, a request to remit the deposited remittance amount to a second virtual account corresponding to the second electronic wallet.

22. A system, comprising:
a first device configured to transmit a remittance request including a remittance amount and an identifier of a second device;
a server configured to:
receive, from the first device, the remittance request,
determine whether a second electronic wallet has been issued to be hosted on the second device and transmit, to the bank, a request to deposit the remittance amount from a first virtual account corresponding to the first electronic wallet to a virtual account corresponding to the server, if an issued result of the determining is negative, and
transmit a request to accept the deposited remittance amount; and
a second device configured to receive the request to accept the deposited remittance amount from the server.

23. The system of claim 22, wherein the second device is further configured to transmit, to the server, a request to remit the deposited remittance amount and an account identifier of a bank account corresponding to the second device, and
wherein the server is further configured to:
receive, from the second device, the request to remit the deposited remittance amount, and
transmit, to the bank, a request to remit the deposited remittance amount to the bank account.

24. The system of claim 22, wherein the second device is further configured to transmit, to the server, a request for the second electronic wallet to be issued, and
wherein the server is further configured to:
receive, from the second device, the request for the second electronic wallet and issue the second electronic wallet to be hosted on the second device, and
transmit, to the bank, a request for the deposited remittance amount to be remitted to a second virtual account corresponding to the issued second electronic wallet.
